(19) United States
(12) Patent Application Publication
(10) Pub. No.: US 2020/0086549 A1
(43) Pub. Date: Mar. 19, 2020

(54) THREE-DIMENSIONAL OBJECT AND METHOD FOR MANUFACTURING THE SAME

(71) Applicant: CASIO COMPUTER CO., LTD., Tokyo (JP)

(72) Inventor: Hideki TAKAHASHI, Tokyo (JP)

(73) Assignee: CASIO COMPUTER CO., LTD., Tokyo (JP)

(21) Appl. No.: 16/539,314

(22) Filed: Aug. 13, 2019

(30) Foreign Application Priority Data
Sep. 13, 2018 (JP) 2018-171968
Jun. 20, 2019 (JP) 2019-114981

(51) Int. Cl. B29C 61/04; B41M 5/00; B41M 7/00

(52) U.S. Cl. CPC B29C 61/04; B41M 5/0047; B29K 2101/12; B41M 7/0081; B41M 5/0064

(57) ABSTRACT

In a three-dimensional object formed by bending and deforming a sheet-like base material made of a thermoplastic resin at a ridge line, a surface of the base material bent and oriented outward at least at the ridge line is covered with a thermal expansion layer that expands when heated to a thermal deformation temperature of the thermoplastic resin or a higher temperature, and the thermal expansion layer is expanded at the ridge line.

### BACKGROUND

### 1. Technical Field

The present invention relates to a three-dimensional object obtained by shaping a sheet-like resin, and a method for manufacturing the same.

### 2. Related Art

Planar sheet or film members molded from thermoplastic resins such as polyvinyl chloride (PVC) and polyethylene terephthalate (PET) are stretched or folded by press forming or vacuum forming to manufacture desired three-dimensional containers and the like (for example, refer to JP 6166304 B2 and JP 2016-198969 A). In addition, due to their transparency and texture, such sheet or film members are formed in a box shape for use as packaging containers and the like (for example, refer to JP 5963930 B1).

### SUMMARY

Those sheets are molded by molding dies tailored to the molded shapes. Thus, in trial production and small-lot production, the manufacturing costs will be high for the volume of manufacture. In addition, it takes a lot of time from the design to the completion including the period for manufacturing the mold, so repeating the specification change in the trial manufacture will increase the time and cost. The folding process is also possible by a manual operation using a ruler or the like. However, high accuracy is required because, once the sheet is bent, the fold remains on the sheet, so redoing is impossible. In addition, it is difficult to stop the fold at a desired position in the sheet without folding to the end of the sheet or to form a curved fold line in the sheet. Furthermore, a high-rigidity sheet due to a certain thickness or the like tends to crack when bent. Even if it can be bent once, when the sheet is refolded such that a mountain fold is turned into a valley fold, the sheet may become broken at the fold.

An object of the present invention is to provide a three-dimensional object in which a sheet-like resin is formed into a desired shape and which can be easily manufactured and is suitable for small-volume production and trial production, and a method for manufacturing the same.

In order to solve the above problems, a three-dimensional object according to the present invention is a three-dimensional object formed by bending and deforming a sheet-like base material made of a thermoplastic resin at a ridge line. A surface of the base material bent and oriented outward at least at the ridge line is covered with a thermal expansion layer that expands when heated to a thermal deformation temperature of the thermoplastic resin or a higher temperature. The thermal expansion layer is expanded at the ridge line.

A three-dimensional object manufacturing method according to the present invention is a method for manufacturing a three-dimensional object in which a sheet-like base material made of a thermoplastic resin is bent and deformed at a ridge line. The three-dimensional object manufacturing method includes: a thermal expansion layer formation step of forming a thermal expansion layer to expand when heated to a predetermined temperature range on a sheet-like base material made of a thermoplastic resin of which a thermal deformation temperature is equal to or lower than the predetermined temperature range; a printing step of drawing a line on at least one surface by a printing material that contains a photothermal conversion component to convert absorbed light into heat and emit the heat; and a light irradiation step of irradiating the surface on which the line is drawn with light to be converted into heat by the photothermal conversion component. In the light irradiation step, the thermal expansion layer immediately below the line is expanded and the base material is bent at the line such that the expanded thermal expansion layer faces outside. Alternatively, in the three-dimensional object manufacturing method according to the present invention, the base material is further configured to transmit light. The three-dimensional object manufacturing method includes: a printing step of drawing a line by the printing material; a thermal expansion layer formation step of forming a thermal expansion layer on one surface of the base material; and a light irradiation step of irradiating the base material with the light. In the printing step, the line is drawn on the one surface of the base material or the base material side of the thermal expansion layer.

According to the three-dimensional object of the present invention, a packaging container or the like of a desired shape can be easily obtained from a thermoplastic resin sheet. According to the three-dimensional object manufacturing method of the present invention, a thermoplastic resin sheet can be easily formed into a desired three-dimensional shape without preparing a mold.

### BRIEF DESCRIPTION OF THE DRAWINGS

FIG. 1A is an external view of a three-dimensional object according to the present invention;

FIG. 1B is a developed view of the three-dimensional object illustrated in FIG. 1A, and is a plan view in a cutting step of a method for manufacturing the three-dimensional object;

FIG. 2A is an external view of a three-dimensional object according to the present invention;

FIG. 2B is a developed view of the three-dimensional object illustrated in FIG. 2A, and is a plan view in a cutting step of a method for manufacturing the three-dimensional object;

FIG. 3 is a partial cross-sectional view schematically illustrating a configuration of a three-dimensional object according to a first embodiment of the present invention;

FIG. 4 is a cross-sectional view schematically illustrating a configuration of a thermal expansion layer-coated resin sheet which is a material of the three-dimensional object according to the first embodiment of the present invention;

FIG. 5 is a cross-sectional view illustrating an outline of a light irradiation device used for manufacturing a three-dimensional object;

FIG. 6 is a cross-sectional view illustrating an outline of a light irradiation device used for manufacturing a three-dimensional object;

FIG. 7 is a flow chart of a three-dimensional object manufacturing method according to the first embodiment of the present invention;

FIG. 8A is a schematic view illustrating the three-dimensional object manufacturing method according to the first embodiment of the present invention, and is a cross-sectional view in a thermal expansion layer formation step;

FIG. 8B is a schematic view illustrating the three-dimensional object manufacturing method according to the first embodiment of the present invention, and is a cross-sectional view in an ink reception layer formation step;

FIG. 8C is a schematic view illustrating the three-dimensional object manufacturing method according to the first embodiment of the present invention, and is a cross-sectional view in a printing step;

FIG. 8D is a schematic view illustrating the three-dimensional object manufacturing method according to the first embodiment of the present invention, and is a cross-sectional view in a light irradiation step;

FIG. 9 is a schematic view illustrating a three-dimensional object manufacturing method according to a modification example of the first embodiment of the present invention, and is a plan view in a cutting step;

FIG. 10 is a partial cross-sectional view schematically illustrating a configuration of a three-dimensional object according to a modification example of the first embodiment of the present invention;

FIG. 11 is a cross-sectional view schematically illustrating a configuration of a thermal expansion layer-coated resin sheet which is a material of the three-dimensional object according to the modification example of the first embodiment of the present invention;

FIG. 12 is a cross-sectional view schematically illustrating a configuration of a thermal expansion layer-coated resin sheet which is a material of the three-dimensional object according to the modification example of the first embodiment of the present invention;

FIG. 13A is a schematic view illustrating a three-dimensional object manufacturing method according to a modification example of the first embodiment of the present invention, and is a cross-sectional view in a printing step;

FIG. 13B is a schematic view illustrating a three-dimensional object manufacturing method according to a modification example of the first embodiment of the present invention, and is a cross-sectional view in a light irradiation step;

FIG. 14 is a flow chart of a three-dimensional object manufacturing method according to a second embodiment of the present invention;

FIG. 15A is a schematic view illustrating the three-dimensional object manufacturing method according to the second embodiment of the present invention, and is a cross-sectional view in a thermal expansion layer formation step;

FIG. 15B is a schematic view illustrating the three-dimensional object manufacturing method according to the second embodiment of the present invention, and is a cross-sectional view in a printing step;

FIG. 15C is a schematic view illustrating the three-dimensional object manufacturing method according to the second embodiment of the present invention, and is a cross-sectional view in a bonding step;

FIG. 15D is a schematic view illustrating the three-dimensional object manufacturing method according to the second embodiment of the present invention, and is a cross-sectional view in a light irradiation step;

FIG. 16A is an external view of a three-dimensional object according to the present invention;

FIG. 16B is a developed view of the three-dimensional object illustrated in FIG. 16A;

FIG. 17 is a partial cross-sectional view schematically illustrating a configuration of a three-dimensional object according to a third embodiment of the present invention;

FIG. 18 is a cross-sectional view schematically illustrating a configuration of a thermal expansion layer-coated resin sheet which is a material of the three-dimensional object according to the third embodiment of the present invention;

FIG. 19 is a cross-sectional view illustrating an outline of a light irradiation device used for manufacturing a three-dimensional object;

FIG. 20A is a schematic view illustrating the three-dimensional object manufacturing method according to the third embodiment of the present invention, and is a cross-sectional view in a printing step;

FIG. 20B is a schematic view illustrating the three-dimensional object manufacturing method according to the third embodiment of the present invention, and is a cross-sectional view in a light irradiation step;

FIG. 21 is a schematic view illustrating a three-dimensional object manufacturing method according to a modification example of the third embodiment of the present invention, and is a cross-sectional view in a printing step;

FIG. 22A is a schematic view illustrating the three-dimensional object manufacturing method according to a fourth embodiment of the present invention, and is a cross-sectional view in a printing step;

FIG. 22B is a schematic view illustrating the three-dimensional object manufacturing method according to the fourth embodiment of the present invention, and is a cross-sectional view in a light irradiation step;

FIG. 23 is a cross-sectional view schematically illustrating a configuration of a thermal expansion layer-coated resin sheet which is a material of the three-dimensional object according to a modification example of the fourth embodiment of the present invention;

FIG. 24 is a partial cross-sectional view schematically illustrating a configuration of a three-dimensional object according to the modification example of the fourth embodiment of the present invention;

FIG. 25 is a cross-sectional view schematically illustrating a configuration of a thermal expansion layer-coated resin sheet which is a material of the three-dimensional object according to the modification example of the fourth embodiment of the present invention;

FIG. 26A is a schematic view illustrating a three-dimensional object manufacturing method according to a modification example of the fourth embodiment of the present invention, and is a cross-sectional view in a printing step;

FIG. 26B is a schematic view illustrating a three-dimensional object manufacturing method according to the modification example of the fourth embodiment of the present invention, and is a cross-sectional view in a light irradiation step;

FIG. 27 is an external view illustrating an outline of a light irradiation device used for manufacturing a three-dimensional object;

FIG. 28 is a schematic view illustrating a three-dimensional object manufacturing method according to a fifth embodiment of the present invention, and is a plan view in a cutting step; and

FIG. 29 is a schematic view illustrating a three-dimensional object manufacturing method according to a fifth embodiment of the present invention, and is a plan view in a cutting step.

### DETAILED DESCRIPTION

Hereinafter, modes for carrying out the present invention will be described in detail with reference to the drawings. However, the modes described below are merely intended to exemplify wires and the like for embodying technical ideas of the embodiments but are not intended to limit the technical ideas of the embodiments to those described below. The members illustrated in the drawings may be exaggerated in size, positional relationship, and the like, for the sake of clarity, and may be simplified in shape. Further, in the following descriptions, the same or similar members and steps are denoted by the same reference numerals, and duplicated descriptions thereof will be appropriately omitted.

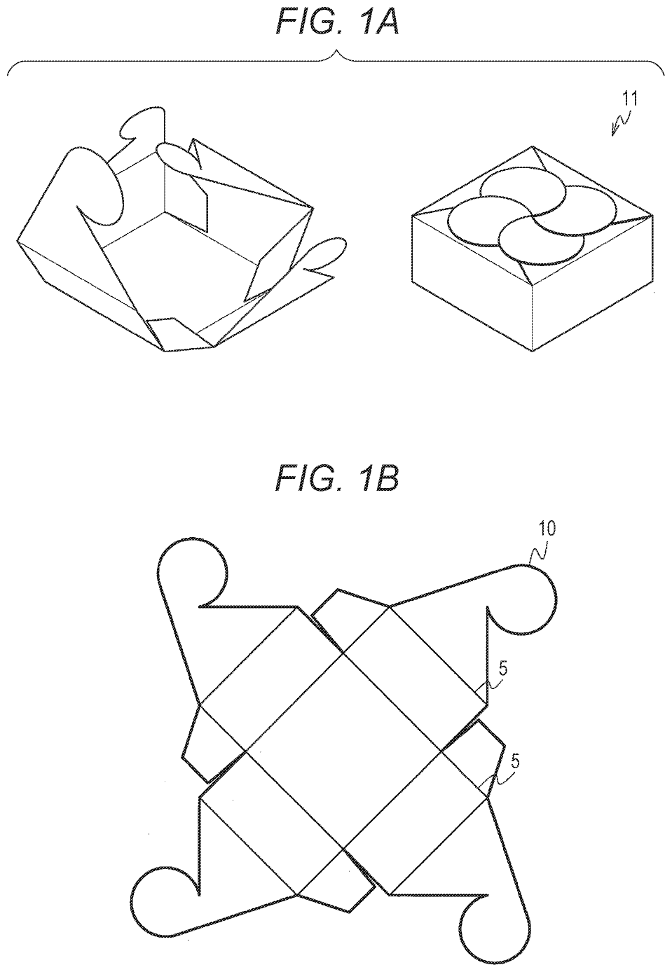

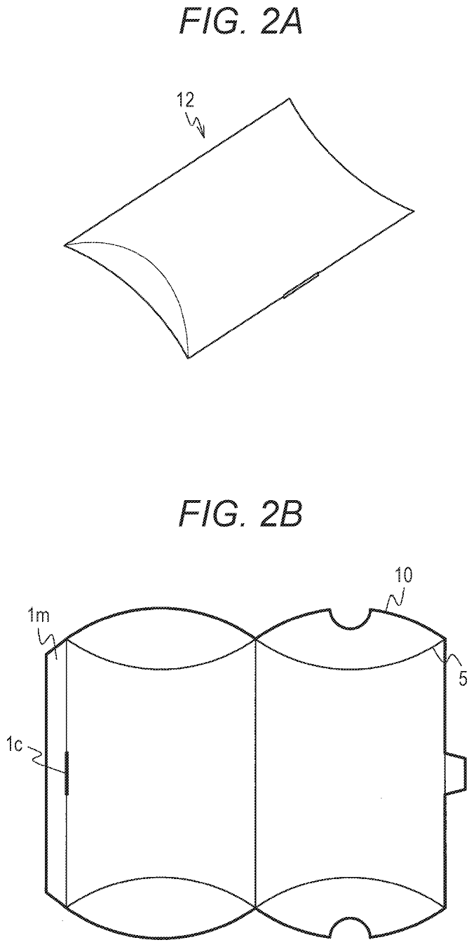

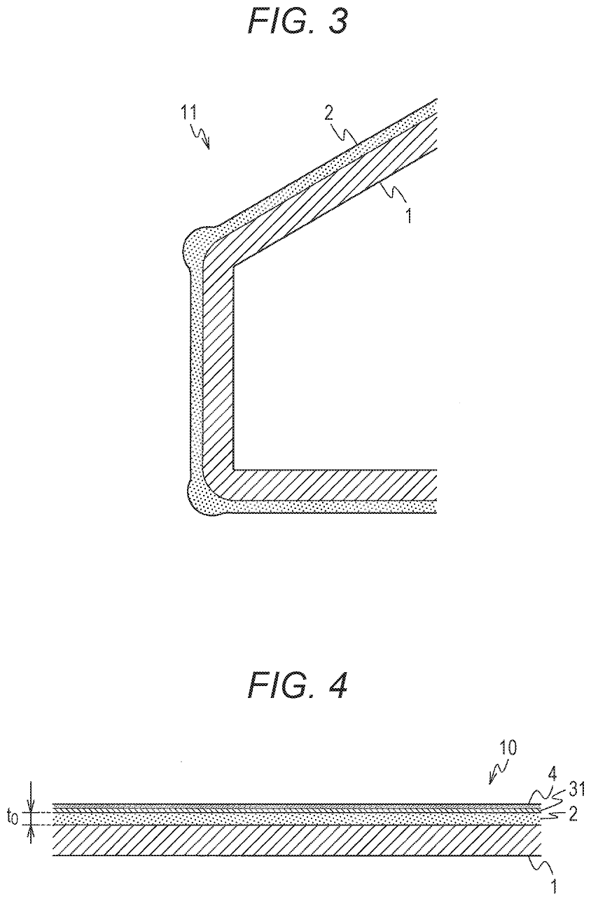

Structures of three-dimensional objects according to the present invention will be described with reference to FIGS. 1A, 1B, 2A, 2B, and 3. FIGS. 1A and 2A are external views of the three-dimensional objects according to the present invention, and FIGS. 1B and 2B are respective developed views of the three-dimensional objects. FIG. 3 is a partial cross-sectional view schematically illustrating a configuration of a three-dimensional object according to a first embodiment of the present invention.

[Sheet Formed Article]

As illustrated in FIG. 1A, a sheet formed article (three-dimensional object) 11 is a box of a short square prism shape, and is assembled by folding a flat sheet cut in a plan-view shape illustrated in FIG. 1B along solid lines as fold lines illustrated in FIG. 1B (photothermal conversion members 5). In addition, the sheet formed article herein refers to an article of a three-dimensional outer shape formed by folding or curving a flat sheet with a uniform thickness. The sheet is rigid and flexible to a certain extent, and has mountain folds (or valley folds) at all fold lines. In the sheet formed article 11, a central square illustrated in FIG. 1B constitutes a bottom surface, rectangles connected to the four sides of the central square constitute side surfaces, and four substantial triangular surfaces connected to the side of the central square opposed to the bottoms of the side surfaces constitute a top surface (lid). Furthermore, small squares connected to other sides of the side surfaces constitutes flaps. Each of the flags is folded inside the adjacent side surface without a gap therebetween. The sheet formed article 11 is fixed in a box shape by folding at right angles along the fold lines and engaging mutually a plurality of substantially circular projections connected to the apexes of the four substantially triangular surfaces constituting the lid.

As illustrated in FIG. 2A, a sheet formed article (three-dimensional object) 12 is a box of four curved surfaces (columnar surfaces) called a pillow shape, and is assembled by folding a flat sheet cut in a plan-view shape illustrated in FIG. 2B along solid lines as fold lines illustrated in FIG. 2B (photothermal conversion members 5), as in the case of the sheet formed article 11. The sheet formed article 12 includes two opposing convex surfaces (bottom and top surfaces) curved to expand outward and two opposing concave surfaces (side surfaces) curved inward. As illustrated in FIG. 2B, the bottom surface and the top surface are composed formed from two linear sides opposed in parallel and two arc-shaped sides projecting inward, and are connected each other by one linear side. An overlap margin (margin) of 1 m is connected to the other linear side of the top surface, and an incision 1c is formed at the center of the foregoing one side. On the other hand, a claw made to conform to the length of the incision 1c is connected to the center of the other linear side of the bottom surface. The side surfaces have a leaf shape (convex lens shape) formed from two arc-shaped sides. Each of the side surfaces is connected by the two arc-shaped sides to both the bottom surface and the top surface. Each of the side surfaces on the bottom surface side has a semicircular cut portion on which a finger is to be placed. The sheet formed article 12 is fixed in a tubular form by folding the overlap margin 1m inward and inserting the claw from the outside into the incision 1c, and connecting the linear sides of the bottom surface and the top surface. At this time, the side surface on the top surface side is laid on the outside of the side surface on the bottom surface side. The sheet formed articles 11 and 12 have folds at the ridge lines and are fixed in a three-dimensional shape without gluing or the like, so these articles can be easily assembled by hand work into packaging containers such as gift boxes.

### First Embodiment

Each of the sheet formed articles 11 and 12 (hereinafter, called as appropriate collectively sheet formed article 11) according to the first embodiment of the present invention includes a base material 1 and a thermal expansion layer 2 laminated on a surface of the base material 1 outside ridge lines, and the thermal expansion layer 2 is swollen at the ridge lines as illustrated in FIG. 3. The sheet formed article 11 according to the present embodiment is manufactured from a thermal expansion layer-coated resin sheet 10 illustrated in FIG. 4.

[Thermal Expansion Layer-Coated Resin Sheet]

A configuration of the thermal expansion layer-coated resin sheet 10 before the formation of the sheet formed article 11 will be described below with reference to FIG. 4. FIG. 4 is a cross-sectional view schematically illustrating a configuration of a thermal expansion layer-coated resin sheet which is a material of the three-dimensional object according to the first embodiment of the present invention. The thermal expansion layer-coated resin sheet 10 is a flat member having a uniform thickness, and is formed by sequentially laminating the base material 1, the thermal expansion layer 2, a release layer 31, and an ink reception layer 4 having uniform thicknesses. The thermal expansion layer-coated resin sheet 10 is a printed material on which printing is performed in black ink constituting photothermal conversion members 5 on the front surface, that is, on the ink reception layer 4. Therefore, the thermal expansion layer-coated resin sheet 10 has a dimension (a fixed size) corresponding to a printing machine for forming the photothermal conversion members 5 at the manufacture of the sheet formed article 11. The size is larger than the developed shape of the sheet formed article 11 (12) (see FIGS. 1B and 2B), for example, the A3 size.

(Base Material)

The base material 1 is a main element of the sheet formed article 11, and is a sheet-like member having rigidity for holding the shape of the sheet formed article 11 as a box and having flexibility. The base material 1 is flat before the formation of the sheet formed article 11 (the thermal expansion layer-coated resin sheet 10). The sheet formed article 11 has creases for mountain folds (or valley folds) at all the ridge lines. The base material 1 is made of a thermoplastic resin, specifically, polyvinyl chloride (PVC), polyethylene terephthalate (PET), polypropylene (PP) and the like. The base material 1 is formed into a non-oriented film or a biaxially oriented film. The base material 1 may further contain a colorant such as a pigment and be tinted in a desired color. The base material 1 has a thickness to have the rigidity described above. On the other hand, however, as the thickness becomes smaller, the base material 1 becomes more difficult to bend and becomes difficult to form a curved surface with a reduction in flexibility. The base material 1 preferably has a thickness of 0.2 to 0.5 mm before formation depending on the material so as to have appropriate rigidity and flexibility.

(Thermal Expansion Layer)

The thermal expansion layer 2 is a member that expands when heated to a predetermined temperature range (expansion temperature range). As described later, the thermal expansion layer 2 locally expands in a linear manner in the manufacturing process of the sheet formed article 11 to apply a load to the base material 1 to be bent by plastic deformation. The thermal expansion layer 2 is a film that contains thermal expansion microcapsules applied to a known thermal expansion sheet, and is formed to a uniform thickness to before the formation of the sheet formed article 11 (the thermal expansion layer-coated resin sheet 10) with a thermoplastic resin as a binder. The thermal expansion layer 2 may further be tinted in a desired color by containing a white pigment such as titanium oxide or a pigment other than black (not containing carbon black). The microcapsules form a shell of a thermoplastic resin and contain a volatile solvent. When heated to reach an expansion temperature range, the microcapsules expand to a size corresponding to the heating temperature and heating time. The thermal expansion layer 2 expands up to about 10 times the volume before expansion depending on the composition of the microcapsules and the like. For the thermal expansion layer 2, the lower limit value (expansion start temperature T_{Es}) of the expansion temperature range can be designed as appropriate from a low temperature of about 70° C. to a high temperature close to 300° C. by selecting a thermoplastic resin and volatile solvent in the microcapsules.

In the present invention, thermal deformation temperature T_{D} of the thermoplastic resin constituting the base material 1 is designed to be a temperature within the expansion temperature range of the thermal expansion layer 2 or lower. In the present embodiment, the thermal deformation temperature T_{D} is preferably equal to or lower than the expansion start temperature T_{Es} of the thermal expansion layer 2, and more preferably is less than the expansion start temperature T_{Es}. The thermal deformation temperature T_{D} of the thermoplastic resin is preferably a temperature at a low load. However, if the expansion start temperature T_{Es} of the thermal expansion layer 2 is too high relative to the thermal deformation temperature T_{D} of the base material 1, when heated to the expansion temperature range together with the thermal expansion layer 2, the base material 1 may become excessively softened, thinner, and melted to get holes or break, and welded to the device. Moreover, after heating is completed and the progress of expansion of the thermal expansion layer 2 is stopped due to natural cooling or the like, there is a possibility that the base material 1 may cause an unintended plastic deformation due to its own weight or the like.

Specifically, if the base material 1 is made from a crystalline resin, the base material 1 is at a temperature less than a fusing point and is easy to cause plastic deformation while keeping a sheet (film) shape at a heating temperature (maximum temperature) set within the expansion temperature range of the thermal expansion layer 2, preferably at a temperature at which the expansion coefficient of the microcapsules becomes maximum (maximum expansion temperature T_{Emax}). That is, as described later in the manufacturing method, when heated to the same temperature, the base material 1 is bent by the load of expansion and deformation of the thermal expansion layer 2. Therefore, the material of the thermal expansion layer 2 is preferably prepared while setting the expansion temperature range according to the thermal properties of the thermoplastic resin constituting the base material 1.

The thermal expansion layer 2 has a larger amount of increase in volume due to expansion (expansion amount) as the thickness (initial thickness) to before molding is larger, so the load acting on the base material 1 due to deformation is higher to make the base material 1 easy to bend. On the other hand, when the initial thickness to of the thermal expansion layer 2 is large, the expansion amount becomes large accordingly. As a result, the sheet formed article 11 has the ridge lines greatly swelling and noticeably lifted. In addition, in the manufacturing process of the sheet formed article 11, heat is less likely to be transmitted to the base material 1. Specifically, the initial thickness to of the thermal expansion layer 2 is preferably 50 to 200 μm, and is further preferably designed according to the thickness of the base material 1 or the like.

The local expansion of the thermal expansion layer 2 is due to local heating to the thermal expansion layer 2. As described later in relation to a manufacturing method, the local heating is caused when the irradiation light is converted to heat and the heat is emitted by the photothermal conversion members 5 made from black ink attached to the surface of the thermal expansion layer-coated resin sheet 10.

(Release Layer)

The release layer 31 is provided as necessary to remove the photothermal conversion members 5 made from black ink and linearly printed on the surface of the thermal expansion layer-coated resin sheet 10 together with the ink reception layer 4 as the top layer in the process of manufacture of the sheet formed article 11. That is, the release layer 31 is releasable from the thermal expansion layer 2 just below. In addition, the release layer 31 does not contain an organic solvent or the like for dissolving the thermal expansion layer 2 at the time of formation, and is made of a material that does not require heating above the expansion start temperature T_{Es} of the thermal expansion layer 2. The release layer 31 is merely required to fix the ink reception layer 4 on the surface until the light irradiation of the thermal expansion layer-coated resin sheet 10 is completed in the process of manufacturing the sheet formed article 11. For example, the release layer 31 may be of low elasticity and may be broken or peeled when the upper surface of the thermal expansion layer 2 (the interface with the release layer 31) is stretched and deformed after completion of the light irradiation. Moreover, the release layer 31 can be a heat-releasable adhesive of which adhesive strength is reduced by heating to a predetermined temperature or more. The predetermined temperature is lower than the expansion start temperature T_{Es} of the thermal expansion layer 2 and is a heating temperature in a region to which the photothermal conversion members 5 are not attached due to light irradiation of the thermal expansion layer-coated resin sheet 10. For example, the release layer 31 can be a known easily releasable adhesive such as a vinyl chloride-vinyl acetate copolymer, which preferably has a thickness of about 1 μm to several μm. In addition, the release layer 31 may have a structure in which a resin film is laminated on the adhesive as described above. That is, the adhesive is applied to the surface of the thermal expansion layer 2 and the resin film is attached to the adhesive. With such a structure, the release layer 31 can efficiently remove the ink reception layer 4 in the process of manufacturing the sheet formed article 11. The resin film preferably has a thickness of about 10 to several tens of μm, and can be a known film commercially available for food packaging and the like.

(Ink Reception Layer)

Since the thermal expansion layer 2 is generally hydrophobic and it is difficult to attach the ink to the thermal expansion layer 2 before expansion, the ink reception layer 4 is provided on the outermost surface of the thermal expansion layer-coated resin sheet 10 so that the black ink constituting the photothermal conversion members 5 can attach to the ink reception layer 4. The ink reception layer 4 can be a layer for use in print sheets for a general ink jet printer. The ink reception layer 4 is made from porous silica or alumina (void type) that allows the ink to be absorbed in the voids, or a high water-absorption polymer (swelling type) or the like to absorb the ink by swelling. The ink reception layer 4 is formed to a thickness of about 10 to several tens μm depending on the material or the like.

[Method for Manufacturing the Sheet Formed Article]

(Manufacturing Devices)

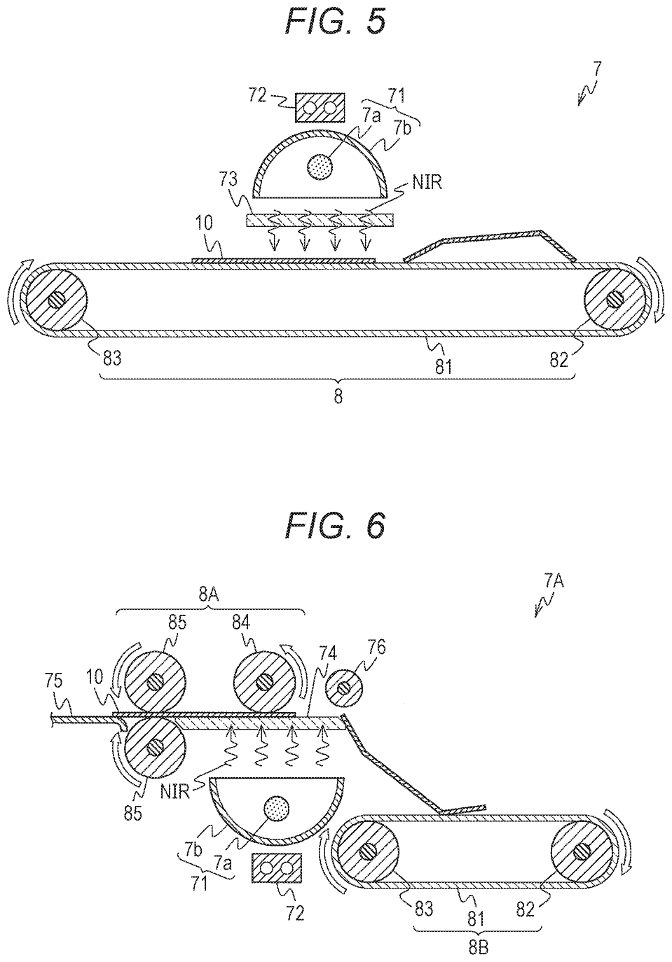

Devices used for manufacturing the sheet formed article according to the present invention will be briefly described. In the manufacture of the thermal expansion layer-coated resin sheet 10 as a material of the sheet formed article 11, there are used coating devices that form the thermal expansion layer 2 before expansion, the release layer 31, and the ink reception layer 4 on the base material 1, and as necessary, a known cutting machine for cutting paper or the like (not illustrated) in order to process the thermal expansion layer-coated resin sheet 10 into a fixed size. In the manufacture of the sheet formed article 11, there are used a printing machine (not illustrated) that prints the photothermal conversion members 5 in black ink on the surface of the thermal expansion layer-coated resin sheet 10, a processing tool (not illustrated) that cuts the thermal expansion layer-coated resin sheet 10 into a developed shape of the sheet formed article 11, and a light irradiation device 7 (see FIG. 5) that heats the photothermal conversion members 5 by irradiating the thermal expansion layer-coated resin sheet 10 with near infrared light to expand the thermal expansion layer 2.

Each of the coating devices is a device for applying a coating material to a sheet-like member to form a coating film having a uniform thickness, which can be a known device of bar coater, roller, or spray type. In particular, the device for forming the thermal expansion layer 2 is particularly a bar coater type suitable for uniform thick coating.

The printing machine is a printing machine for printing the photothermal conversion members 5 in black ink, and can be selected from among known devices of offset or ink jet type corresponding to printing quality. In particular, the ink jet type suitable for small-volume production is preferred. In addition, the printing machine is compatible with the dimensions and thickness of the thermal expansion layer-coated resin sheet 10 as a printed matter. The printing machine is configured such that a printed matter is not heated exceeding the expansion start temperature T_{Es} of the thermal expansion layer 2.

The processing tool is a tool for cutting the thermal expansion layer-coated resin sheet 10 into a developed shape of the sheet formed article 11 (see FIG. 1B). Specifically, as the processing tool, there is used any of known tools that correspond to the rigidity and thickness of the thermal expansion layer-coated resin sheet 10, including edged tools such as scissors or a cutter knife, a punching machine, or an electric thread saw, and that is configured such that non-processed materials are not heated exceeding the expansion start temperature T_{Es} of the thermal expansion layer 2.

The light irradiation device 7 is a device that irradiates the surface of the thermal expansion layer-coated resin sheet 10 with the photothermal conversion members 5 (printed surface) with light to heat the thermal expansion layer 2. Hereinafter, the light irradiation device will be briefly described with reference to FIGS. 5 and 6. FIGS. 5 and 6 are cross-sectional views illustrating an outline of the light irradiation device used for manufacturing a sheet formed article.

As illustrated in FIG. 5, the light irradiation device 7 includes a light irradiation unit 71, a cooler 72, a protection plate 73, and a transport mechanism 8. The light irradiation unit 71 is a main unit of the light irradiation device 7 that irradiates an object to be processed (the cut thermal expansion layer-coated resin sheet 10) with light, and includes a light source 7a and a reflecting plate 7b. In the light irradiation device 7, the light irradiation unit 71 is provided above a transport mechanism 8 to transport the object to be processed to irradiate the upper surface of the object to be processed with light. The light irradiation device 7 is structured to irradiate the object to be processed with light over its entire length (full width) in a transport-width direction (the direction perpendicular to the sheet of FIG. 5) that can be supported by the light irradiation device 7. The light source 7a emits light including near infrared rays converted to heat by the photothermal conversion members 5. The light source 7a is a halogen lamp, for example. The reflecting plate 7b is formed in a substantially semi-cylindrical curved shape and has a mirror surface on the inner side to efficiently irradiate the object to be processed with light from the light source 7a. The reflecting plate 7b covers the side of the light source 7a opposite to the side facing the object to be processed, that is, the upper side. The light irradiation unit 71 can be a component of a known device for forming a three-dimensional object having irregularities on the surface from a thermal expansion sheet formed by laminating the thermal expansion layer 2 on a thick sheet of paper or the like. The cooler 72 is an air-cooling fan, a water-cooling radiator, or the like, and is provided in the vicinity of the reflecting plate 7b. The protection plate 73 is a flat plate material horizontally disposed just under the entire light irradiation unit 71. The protection plate 73 is provided as necessary to prevent the object to be processed from contacting the reflecting plate 7b and the light source 7a when lifted from the transport path, and prevent the object to be processed from excessively generating heat when approaching the light source 7a. The protection plate 73 can be a glass plate having a high transmittance of light (near infrared light), for example, so as not to block the light from the light irradiation unit 71.

The transport mechanism 8 transports the object to be processed in one horizontal direction at a constant speed so that the object to be processed is entirely moved (along length in the transport direction) through at least a region to be irradiated with light from the light irradiation unit 71, that is, by a distance with which the object to be processed is completely passed under the light irradiation unit 71. The transport mechanism 8 is, for example, a belt conveyor, and includes a belt 81, a head pulley (drive pulley) 82, a tail pulley 83, and a motor (not illustrated) for rotationally driving the head pulley 82. The belt 81 on which the object to be processed is to be placed is made of rubber or the like having a low thermal conductivity so as not to propagate heat in a planar direction in the thermal expansion layer-coated resin sheet 10 as the object to be processed.

The light irradiation device 7 can also vertically reverse the light irradiation unit 71 to irradiate the lower surface of the object to be processed (the thermal expansion layer-coated resin sheet 10) with light. In this case, since the light irradiation unit 71 is to be disposed under the transport mechanism 8 or under the upper belt 81, the belt 81 needs to be a translucent member that does not block the light from the light irradiation unit 71. The light transmitting belt is formed of, for example, a glass cloth impregnated with a highly heat resistant resin. The light transmitting belt can be a belt in a belt conveyor used for an appearance inspection of a product or the like.

The transport mechanism 8 is not limited to a belt conveyor, and may include, for example, a roller conveyor and a movable stage on which the object to be processed is to be placed (refer to a third embodiment described later). Alternatively, the transport mechanism 8 may be a known linear motion mechanism such as a rack and pinion gear system or a ball screw system, which is disposed avoiding the light irradiation area and connected to the edge of the stage. The transport mechanism 8 may be a linear motion mechanism that moves the light irradiation unit 71 in one direction instead of the object to be processed. The light irradiation device 7 may not include the transport mechanism 8 but the light irradiation unit 71 may include a plurality of light sources 7a to irradiate the object to be processed with light in a planar form so that the upper surface and the lower surface of the object to be processed can be entirely irradiated with light at the same time.

Alternatively, as illustrated in FIG. 6, a light irradiation device 7A includes a light irradiation unit 71, a cooler 72, a stage 74, a carry-in guide plate 75, a pressing roller 76, a transport mechanism 8A, and a transport mechanism 8B. The light irradiation unit 71 and the cooler 72 have the same structure as the light irradiation device 7 except that the light irradiation unit 71 is vertically reversed in order to emit light upward. The stage 74 is a flat plate member on which the object to be processed is to be placed, and is horizontally disposed over the entire area immediately above the light irradiation unit 71 and behind the light irradiation unit 71. The stage 74 is provided up to the front end of the light irradiation area so as not to prevent the deformation of the object to be processed by light irradiation. The stage 74 has a high light transmittance so that the light from the lower light irradiation unit 71 can be applied to the lower surface of the object to be processed. The stage 74 is made of a material with a high thermal conductivity, as with the belt 81 in the light irradiation device 7, for example, a glass plate. The carry-in guide plate 75 is a horizontal flat plate member for supporting the supplied object to be processed, and is provided on the rear side of the stage 74 to guide the object to be processed onto the stage 74 by the transport mechanism 8A. The pressing roller 76 is disposed on the upper side of the object to be processed and in the vicinity of the front end of the light irradiation area. The pressing roller 76 is provided as necessary to press the object to be processed from above to prevent the object to be processed from being lifted from the stage 74 and moving away from the light irradiation unit 71. The pressing roller 76 is rotatably supported by an axis in the transport-width direction so as not to hinder the transport of the object to be processed even in contact with the object to be processed.

The transport mechanism 8A transports the object to be processed in one horizontal direction at a constant speed to pass the light irradiation area. The transport mechanism 8A is a sheet loader applied to a transport mechanism in a printing machine or the like, and includes a main transport roller 84, transport rollers 85 and 85, and a motor (not illustrated) for rotationally driving these rollers. The main transport roller 84 is disposed on the upper side of the stage 74, and conveys the object to be processed while pressing the object to be processed from above onto the stage 74 and sliding the same. The main transport roller 84 is preferably disposed at the center or rear side of the light irradiation area as seen in the transport direction so as not to prevent the deformation of the object to be processed by the light irradiation. The transport rollers 85, 85 hold the object to be processed on both sides in a pair of upper and lower, and transport the workpiece from the top of the carry-in guide plate 75 onto the stage 74. The main transport roller 84 and the transport rollers 85, 85 are provided over the entire transport-width direction (total width) so as to transport the object to be processed in one direction regardless of the plan-view shape of the object to be processed, that is, the developed shape of the sheet formed article 11.

The transport mechanism 8B is provided as necessary to smoothly carry out the object having undergone the processing (light irradiation) from the light irradiation area, and is disposed below the stage 74 near the front side of the stage 74. The transport mechanism 8B is, for example, a belt conveyor similar to the transport mechanism 8 of the light irradiation device 7 (see FIG. 5).

(Method for Manufacturing the Sheet Formed Article)

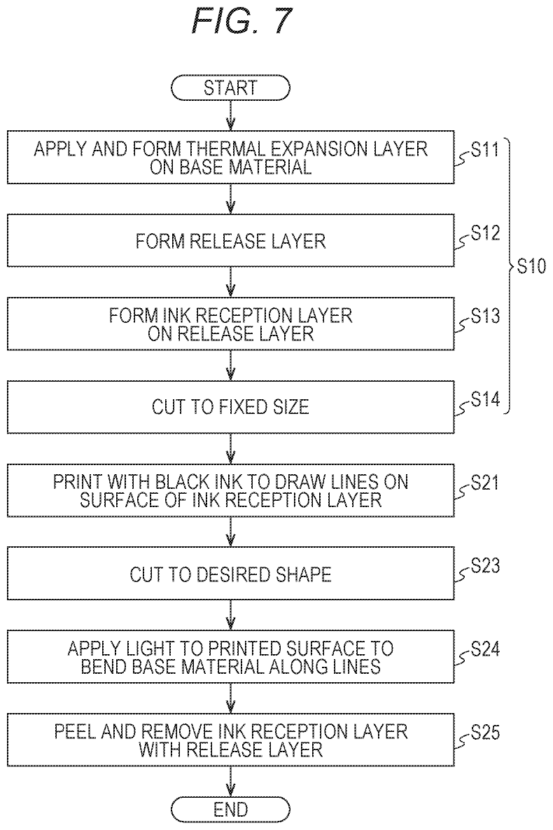

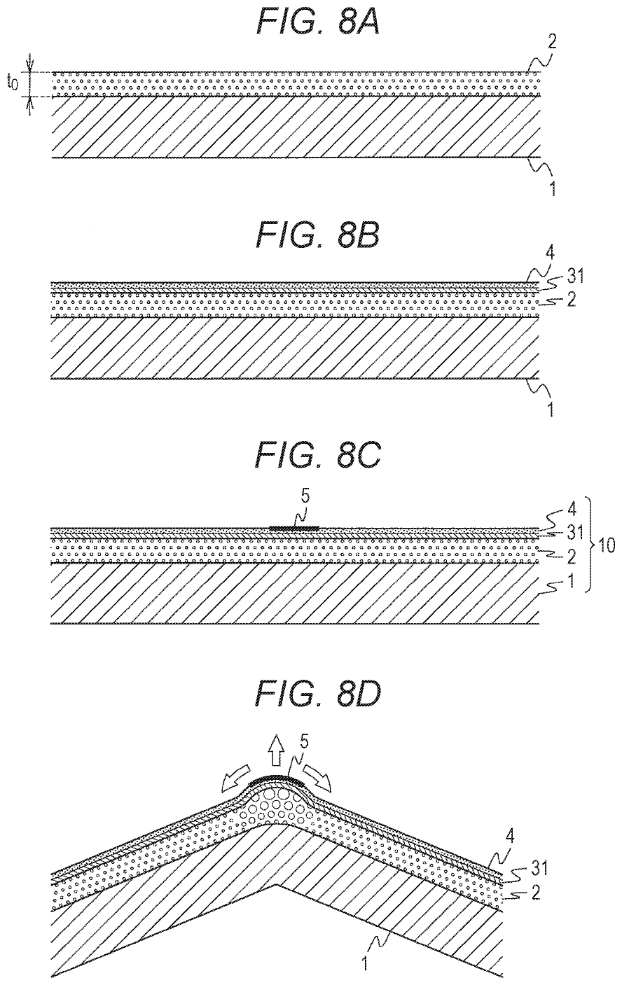

A method for manufacturing the sheet formed article according to the first embodiment will be described with reference to FIGS. 7, 8A to 8D, and to FIGS. 1 to 3 as appropriate. FIG. 7 is a flow chart of the three-dimensional object manufacturing method according to the first embodiment of the present invention. FIGS. 8A to 8D are schematic diagrams illustrating the three-dimensional object manufacturing method according to the first embodiment of the present invention. FIG. 8A is a cross-sectional view in a thermal expansion layer formation step, FIG. 8B is a cross-sectional view in an ink reception layer formation step, FIG. 8C is a cross-sectional view in a printing step, and FIG. 8D is a cross-sectional view in a light irradiation step. As illustrated in FIG. 7, in the method for manufacturing the sheet formed article according to the present embodiment, a thermal expansion layer-coated resin sheet manufacturing step S10 of manufacturing the thermal expansion layer-coated resin sheet 10, a printing step S21, a cutting step S23, a light irradiation step S24, and an ink removal step S25 are sequentially performed. In the thermal expansion layer-coated resin sheet manufacturing step S10, a thermal expansion layer formation step S11, a release layer formation step S12, and an ink reception layer formation step S13 are sequentially performed, and then a cutting step S14 is performed if necessary.

In the thermal expansion layer formation step S11, as illustrated in FIG. 8A, the thermal expansion layer 2 is formed on one surface (front side) of the base material 1. The base material 1 is, for example, in the form of a long roll having a size before cutting corresponding to the coating device. thermal expansion microcapsules, a white pigment, and a thermoplastic resin solution are mixed to prepare a slurry, the slurry is applied to the base material 1 with a coating device, dried, and, if necessary, overcoated to form the thermal expansion layer 2 of the constant thickness t₀. In FIGS. 8A to 8D and other cross-sectional views illustrating other methods for manufacturing a three-dimensional object described later, the thermal expansion layer 2 is represented in a dot pattern imitating microcapsules, and the degree of expansion is indicated by the diameter of dots (circles).

In the release layer formation step S12, the release layer 31 is formed on the thermal expansion layer 2 (see FIG. 8B). Then, in the ink reception layer formation step S13, as illustrated in FIG. 8B, the ink reception layer 4 is formed on the release layer 31. In these steps S12 and S13, the respective materials of the release layer 31 and the ink reception layer 4 are applied by coating devices and dried to form the layers with predetermined thicknesses.

In the cutting step S14, the base material 1 and the thermal expansion layer 2, the release layer 31, and the ink reception layer 4 thereon are cut to obtain the thermal expansion layer-coated resin sheet 10 (see FIG. 4) of dimensions corresponding to a printing machine used in the subsequent printing step S21.

In the printing step S21, as illustrated in FIGS. 8C and 1B or 2B, the photothermal conversion members 5 are linearly printed in black ink on the ink reception layer 4 on the surface of the thermal expansion layer-coated resin sheet 10. FIGS. 8C, 8D, and cross-sectional views described later illustrate cross sections perpendicular to the line (photothermal conversion member 5). Here, the photothermal conversion member will be described.

Each of the photothermal conversion members 5 is a black pattern linearly formed on the surface of the thermal expansion layer-coated resin sheet 10. The sheet formed article 11 is formed by bending the base material 1 inside along the line. In the present embodiment, the photothermal conversion member 5 is formed on the surface of the base material 1 on the thermal expansion layer 2 side and thus corresponds to a mountain fold line. The photothermal conversion member 5 is a member that absorbs light of a specific wavelength range, for example, near-infrared light (wavelength 780 nm to 2.5 μm), converts the light into heat, and emits the heat. Specifically, the photothermal conversion member 5 is formed from a general black (K) printing ink containing carbon black. When irradiated with light, the photothermal conversion member 5 emits heat to heat the thermal expansion layer 2 and the base material 1 so that the thermal expansion layer 2 expands and the base material 1 can be plastically deformed. Further, in the printing step S21, the photothermal conversion member 5 may be printed not only as a mountain fold line but also as an outline (thick lines in FIGS. 1B and 2B) to be a cutting line in the subsequent cutting step S23. The term “light” here refers to near infrared rays (near infrared light) to be converted into heat by carbon black of the photothermal conversion member 5, unless otherwise stated. Moreover, instead of light, electromagnetic waves including radio waves and the like can be used as far as they are converted into heat.

As the density of carbon black is higher, that is, the color is darker (more blackish), the heat generation temperature of the photothermal conversion member 5 when irradiated with light increases. Accordingly, the carbon black is adjusted to the density (black density) at which the thermal expansion layer 2 and the base material 1 are heated to an appropriate temperature in the subsequent light irradiation step S24. In addition, as the line width of the photothermal conversion member 5 (the length as seen in the lateral direction of the drawing) is larger, the photothermal conversion member 5 expands in a wider area in the thermal expansion layer 2 and the expansion amount (increase in the volume) becomes larger. This makes it possible to increase the load of the thermal expansion layer 2 on the base material 1 so that the base material 1 can be bent at larger angles. With a sufficiently large line width, the photothermal conversion member 5 can bend the base material 1 even if the black density is low to a certain extent. However, when the line width of the photothermal conversion member 5 is excessively large, the ridge line of the sheet formed article 11 has a low curvature and is rounded, and furthermore, the ridge line becomes a double line. On the contrary, when the line width of the photothermal conversion member 5 is too small, the expansion amount of the thermal expansion layer 2 is insufficient, and the heated region of the base material 1 is narrow, and the base material 1 cannot be bent. Furthermore, even if the black density is high, the absolute amount of carbon black is insufficient and the thermal expansion layer 2 does not expand. The photothermal conversion member 5 is designed to be high in black density and be large in line width so that, as the base material 1 is thicker, the photothermal conversion member 5 has a higher load acted on the base material 1 and the heat from the photothermal conversion member 5 propagates to the entire base material 1 in the thickness direction. In the subsequent light irradiation step S24, when the light output is high and the irradiation time is long, the expansion amount of the thermal expansion layer 2 increases. Therefore, the photothermal conversion member 5 is preferably set to have a line width as well as the black density depending on the thickness of the base material 1, the irradiation condition of light, and the like. Furthermore, the line width and the black density may be changed according to the bending angle to be determined. In addition, in the case of printing the outline described above, the outline is printed at a black density (gray) and with a line width such that the thermal expansion layer 2 is not heated exceeding the expansion start temperature T_{Es}, or the inside of the outlie is cut and removed in the cutting step S23.

In the cutting step S23, the thermal expansion layer-coated resin sheet 10 on which the photothermal conversion member 5 is formed is cut out along the outline illustrated by a thick line in FIG. 1B (or FIG. 2B) into a developed shape of the sheet formed article 11.

In the light irradiation step S24, the surface (front surface) of the cut thermal expansion layer-coated resin sheet 10 on which the photothermal conversion members 5 are printed is irradiated with light by the light irradiation device 7 (7A). The thermal expansion layer-coated resin sheet 10 is transported by the transport mechanism 8 (8A) and the portions of the thermal expansion layer-coated resin sheet 10 on which the photothermal conversion members 5 are printed enter the light irradiation area, and the light is incident on and absorbed by the photothermal conversion members 5. Accordingly, the light is converted into heat and the photothermal conversion members 5 generate heat to heat the thermal expansion layer 2. Then, the heat further propagates from the surface of the thermal expansion layer 2 in the thickness direction to heat the base material 1. The portions of thermal expansion layer 2 having reached the expansion start temperature T_{Es} foam and start to expand in four directions centering on the lines from immediately below the linear photothermal conversion members 5. As illustrated by void arrows in FIG. 8D, the thermal expansion layer 2 expands mainly to a surface having no barrier, and further expand outward in the line width direction. At this time, when the base material 1 has reached the thermal deformation temperature T_{D} or more, a force to push the base material 1 to the outside of the thermal expansion layer 2 acts on the base material 1 as illustrated by the void arrows in the drawing. When the base material 1 is plastically deformed, the thermal expansion layer-coated resin sheet 10 is folded and bent toward the base material 1 on both sides of the line (the photothermal conversion member 5). When the portions of the thermal expansion layer-coated resin sheet 10 on which the photothermal conversion members 5 are printed are withdrawn from the light irradiation area and the light irradiation of these portions is stopped and a predetermined time (short time) elapses, the base material 1 having been heated by the photothermal conversion members 5 is cooled to a temperature lower than the thermal deformation temperature T_{D}, thereby to complete the deformation of the portions of the thermal expansion layer-coated resin sheet 10 on which the photothermal conversion members 5 are printed. The thermal expansion layer-coated resin sheet 10 is gradually bent and the bending angle is gradually increased when the base material 1 is at the thermal deformation temperature T_{D} or more and the expansion of the thermal expansion layer 2 is in progress. Therefore, unless the expansion of the thermal expansion layer 2 is saturated, the bending angle of the ridge lines becomes larger as the light irradiation time is longer. The light irradiation time can be adjusted by the transport speed of the light irradiation device 7.

In the present embodiment, in the case of using the light irradiation device 7 that irradiates light from the top, the thermal expansion layer-coated resin sheet 10 is processed with the surface facing upward, and the ridge lines are lifted as mountain folds as illustrated in FIG. 5. On the other hand, in the case of using the light irradiation device 7A that irradiates light from below, the thermal expansion layer-coated resin sheet 10 is processed with the surface facing downward, and the ridge lines form valley folds with ends lifted as illustrated in FIG. 6.

When the thermal expansion layer 2 has reached the expansion start temperature T_{Es}, the base material 1 has preferably reached the thermal deformation temperature T_{D} or more. When the base material 1 is at a temperature lower than the thermal deformation temperature T_{D}, the thermal expansion layer 2 expands leaning to the front side. Accordingly, the expansion of the thermal expansion layer 2 to the line width direction becomes smaller. After that, even when the base material 1 reaches the thermal deformation temperature T_{D}, the load on the base material 1 becomes lower and the bending angle becomes smaller. In the present embodiment, since the thermal expansion layer 2 is increased in temperature earlier than the base material 1 due to the heated photothermal conversion members 5. Thus, as described above, the expansion start temperature T_{Es} of the thermal expansion layer 2 is preferably higher than the thermal deformation temperature T_{D} of the base material 1. The heating temperature (maximum temperature) of the thermal expansion layer 2 is preferably around the maximum expansion temperature T_{Emax} (approximately T_{Es}+30 to 50° C.), specifically, (T_{Emax}+5° C.) or less. Therefore, the photothermal conversion members 5 are designed to have a black density so as to generate heat at T_{Es} or more and T_{D} or more. Preferably, the photothermal conversion members 5 are designed to have a black density to generate heat near T_{Emax}.

In addition, when the thermal expansion layer-coated resin sheet 10 is bent in the light irradiation region, the distance between the photothermal conversion member 5 on the surface of the thermal expansion layer-coated resin sheet 10 and the light source 7a changes, and thus the thermal expansion layer-coated resin sheet 10 may not be heated to the designed temperature. On the other hand, after the photothermal conversion member 5 is irradiated with light and generates heat, it takes some time until the heat propagates to the thermal expansion layer 2 and the base material 1 and the thermal expansion layer 2 and the base material 1 to start expansion and bending. Therefore, in the light irradiation step S24, the thermal expansion layer-coated resin sheet 10 preferably starts to bend after passing through the light irradiation area of the light irradiation device 7 (7A). The output of the light source 7a of the light irradiation device 7 and the transport speed are set such that the photothermal conversion member 5 is irradiated with light for a sufficient time to generate heat to a necessary temperature and that the thermal expansion layer-coated resin sheet 10 bends at the timing described above. In addition, the transport direction of the thermal expansion layer-coated resin sheet 10 is not particularly specified as far as the cut thermal expansion layer-coated resin sheet 10 (the developed shape of the sheet formed article 11) falls within the transport width of the light irradiation device 7 (7A). However, the transport-direction length of the photothermal conversion member 5 for forming a ridge line on one side of the sheet formed article 11 is preferably short. Therefore, the sheet formed article 11 is preferably transported in the right-left direction or the up-down direction in FIG. 1B.

Furthermore, in the case of using the light irradiation device 7, the thermal expansion layer-coated resin sheet 10 (the developed shape of the sheet formed article 11) preferably starts to bend after passing through the light irradiation area. While there is left an area yet to be irradiated with light by the light irradiation device 7, when the area having been already irradiated with light bends, the thermal expansion layer-coated resin sheet 10 may be lifted from the belt 81 as a predetermined transport path in the light irradiation area and may not be heated to the designed temperature, depending on the shape of the sheet formed article 11. On the other hand, when the light irradiation device 7A is used, the thermal expansion layer-coated resin sheet 10 is transported in a state of being entirely held at two places between the transport rollers 85 and 85, and between the main transport roller 84 and the stage 74 in the transport-width direction and being in contact with the stage 74. Accordingly, the distance between the light source 7a of the light irradiation unit 71 and the object to be processed is kept constant. Therefore, even if the entire thermal expansion layer-coated resin sheet 10 starts to bend before passing through the light irradiation area, the light is uniformly applied. Thus, the developed shape of the sheet formed article 11 may be large in dimensions.

In the ink removal step S25, the ink reception layer 4 is peeled off by the release layer 31 from the surface of the bent thermal expansion layer-coated resin sheet 10. Thereby, the photothermal conversion member 5 as a black line on a ridge line is removed, whereby the sheet formed article 11 illustrated in FIG. 3 can obtained.

The sheet formed article 11 is further assembled into a box as illustrated in FIG. 1A. At that time, the fold line formed in the light irradiation step S24 is further deeply bent as necessary to increase the bending angle or extended to decrease the bending angle by a certain amount of external force by manual work or the like. Since the fold line itself is formed in the light irradiation step S24 and has a fold, the position of the fold line (ridge line) will not be shifted, and the base material 1 will not be cracked. Further, since the sheet formed article 12 is in a state in which the side surfaces rise from the top surface and the bottom surface on the arc-shaped fold lines and each of the side surfaces is curved. Thus, the straight fold line between the top surface and the bottom surface and others are deeply folded as necessary and the claw is inserted into the incision 1c, whereby the sheet formed article 12 is completed (see FIGS. 2A and 2B). Alternatively, the sheet formed article 12 may be assembled by bonding the front surface (the thermal expansion layer 2) and the back surface (the base material 1) of an end of the bottom surface with an adhesive applied to the overlap margin 1m (see FIG. 2B) as a gluing margin or may be assembled by thermocompression bonding. The thermocompression bonding is performed when the base material 1 is made of a resin material that can be thermocompression-bonded at a temperature lower than the expansion start temperature T_{Es} of the thermal expansion layer 2. In these cases, the claw and incision 1c are not formed.

### Modification Example

In the cutting step S23, the thermal expansion layer-coated resin sheet 10 may not be cut along all along the outlines, as long as the bending in the light irradiation step S24 is not impeded. In this case, after the light irradiation step S24, the bent thermal expansion layer-coated resin sheet 10 is cut along the remaining outlines using scissors or the like to cut off unnecessary portions.

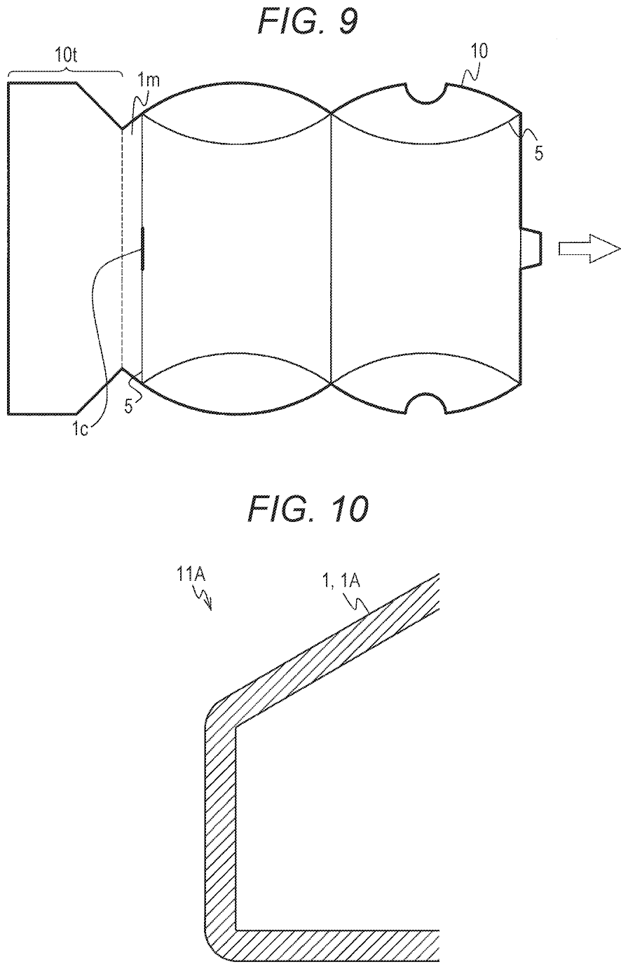

When the light irradiation device 7A is used in the light irradiation step S24, the thermal expansion layer-coated resin sheet 10 is not held after its rear end has passed through the main transport roller 84, and light irradiation of the rear end and its vicinity will not be controlled. Therefore, for example, as for the sheet formed article 12 (see FIG. 2B) having ridge lines near the ends of the developed shape, a grip portion 10t is preferably coupled to one end in the cutting step S23, as illustrated in FIG. 9. Here, the grip portion 10t is coupled to the overlap margin 1m which is to be folded inward by the assembly of the sheet formed article 12. The thermal expansion layer-coated resin sheet 10 is supplied to the light irradiation device 7A such that the grip portion 10t is at the rear end. FIG. 9 illustrates the transport direction of the thermal expansion layer-coated resin sheet 10 by a void arrow. The grip portion 10t is formed such that the shortest transport-direction length of the grip portion 10t from the end to the photothermal conversion member 5 is equal to or longer than the distance from the position of contact with the main transport roller 84 to the front end of the light irradiation area in the light irradiation device 7A. Further, the transport-width-direction length of the grip portion 10t is set such that the grip portion 10t is sufficiently firmly held by the main transport roller 84 and the stage 74, and that the thermal expansion layer-coated resin sheet 10 is not transported in a state of being inclined to the transport-width direction. In the light irradiation step S24, with the grip portion 10t left, all the photothermal conversion members 5 in the thermal expansion layer-coated resin sheet 10 can be uniformly irradiated with light using the light irradiation device 7A.

The photothermal conversion members 5 can also be formed without using a printing machine. In the printing step S21, for example, mountain fold lines are formed on the surface of the thermal expansion layer-coated resin sheet 10 by hand-drawing with a writing instrument such as a black-ink felt pen, India ink and ink brush, and a pencil. The writing instrument is preferably easy to draw lines with a constant black density and a constant line width, and is also preferably less high in writing pressure since the thermal expansion layer 2 is soft. Specifically, the writing instrument is preferably a felt pen.

The sheet formed article 11 may not be subjected to the ink removal step S25 depending on the application such as trial manufacture, and the photothermal conversion members 5 may remain on the surface along the ridge lines. In this case, the thermal expansion layer-coated resin sheet 10 may not include the release layer 31, and therefore, the release layer formation step S12 is not performed.

The bent thermal expansion layer-coated resin sheet 10 may be turned into a sheet formed article 11A only made from the bent base material 1 as illustrated in FIG. 10 by peeling off the ink reception layer 4 together with the thermal expansion layer 2 in the ink removal step S25. Since the sheet formed article 11A does not have the thermal expansion layer 2, the ridge lines do not rise and stand out. In addition, the sheet formed article 11A has the texture of the base material 1, and may have transparency depending on the material of the base material 1. The sheet formed article 11A is manufactured from a thermal expansion layer-coated resin sheet 10B illustrated in FIG. 11. FIG. 11 is a cross-sectional view schematically illustrating a configuration of a thermal expansion layer-coated resin sheet which is a material of the three-dimensional object according to the modification example of the first embodiment of the present invention.

In order to make the thermal expansion layer 2 peelable from the base material 1, the thermal expansion layer-coated resin sheet 10B includes a release layer 31A between the thermal expansion layer 2 and the base material 1 as illustrated in FIG. 11 in place of the release layer 31 of the thermal expansion layer-coated resin sheet 10. The configurations of the base material 1, the thermal expansion layer 2, and the ink reception layer 4 are as described in relation to the above embodiment.

(Release Layer)

The release layer 31A is provided to remove the thermal expansion layer 2 expanded on the ridge line from the bent base material 1 (the sheet formed article 11A) in the manufacturing process of the sheet formed article 11A. The release layer 31A has at least temporary heat resistance to the heating temperature at which to expand the thermal expansion layer 2 in the manufacturing process of the sheet formed article 11A, has adhesive strength with which the release layer 31A is not peeled off when the thermal expansion layer 2 expands and the base material 1 bends, and forms a coating film that is flexible so as not to prevent the bending of the base material 1. The release layer 31A can be, for example, a thermosetting adhesive that can be cured at a temperature at which the base material 1 does not melt, or an ultraviolet curable adhesive. The release layer 31A preferably has a thickness of about 1 μm to several μm. Further, the release layer 31A may have a structure in which a flexible resin film is laminated on the adhesive. The resin film preferably has a thickness of about 1 to 20 μm so as not to inhibit heat transfer from the thermal expansion layer 2 to the base material 1, and can be a known film commercially available for food packaging and the like. Examples of the resin film include ethylene-vinyl alcohol copolymer (EVOH) resin film. Furthermore, the release layer 31A may be made from a resin film alone, which can be formed by thermocompression bonding (lamination) on the base material 1. The thermocompression bonding may be based on any heat sealing (heat welding) property of the base material 1 or the resin film constituting the release layer 31A.

(Method for Manufacturing the Sheet Formed Article)

According to the method for manufacturing the sheet formed article according to the present modification example, the thermal expansion layer-coated resin sheet manufacturing step S10 of manufacturing the thermal expansion layer-coated resin sheet 10B, the printing step S21, the cutting step S23, the light irradiation step S24, and the ink removal step S25 (thermal expansion layer removal step) are sequentially performed as illustrated in FIG. 7. Moreover, in thermal expansion layer-coated resin sheet manufacturing step S10, the release layer formation step S12 and the ink reception layer formation step S13 of the step S10 in the above embodiment are exchanged in order. That is, the thermal expansion layer 2 is formed on the surface of the release layer 31A on the base material 1. Further, in the ink removal step S25, the thermal expansion layer 2 is peeled off from the bent thermal expansion layer-coated resin sheet 10B to form the sheet formed article 11A. Moreover, in the presence of a gluing margin (the overlap margin 1m) as in the sheet formed article 12 (see FIGS. 2A and 2B), the opposing portions of the base material 1 can be bonded together by thermocompression bonding.

After the thermal expansion layer 2 is formed on the release layer 31A made of a resin film, the release layer 31A and the base material 1 may be thermocompression-bonded at a temperature lower than the expansion start temperature T_{Es} of the thermal expansion layer 2. Further, in the present modification example, the thermal expansion layer 2 and the base material 1 can be made separable from each other without providing the release layer 31A. Thus, the base material 1 is made from a resin that can be thermocompression-bonded at a temperature lower than the expansion start temperature T_{Es} of the thermal expansion layer 2. Specifically, the thermal expansion layer 2 is formed on release paper or the like, the surface of the thermal expansion layer 2 and the base material 1 are thermocompression-bonded, and the release paper is peeled off to form the ink reception layer 4. Alternatively, the ink reception layer 4 may be formed on release paper or the like, and the thermal expansion layer 2 may be formed thereon.

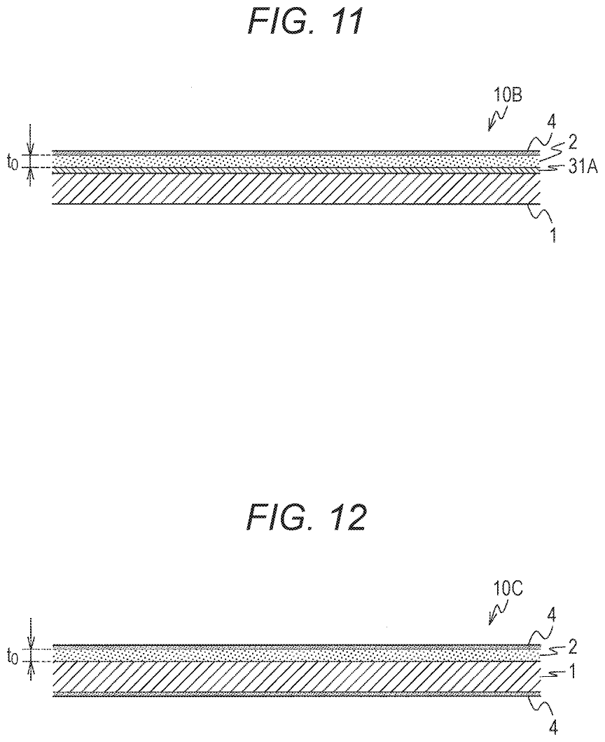

The sheet formed article 11 can also be manufactured by printing a black line on the surface (back surface) of the thermal expansion layer-coated resin sheet on the base material 1 side and irradiating this surface with light. When the sheet formed article 11 is assembled into a box, lines are printed on the inner surface, the printed lines are on the inside and are difficult to recognize visually, so that the ink removal step S25 is not necessary. The sheet formed article 11 is manufactured from a thermal expansion layer-coated resin sheet 10C illustrated in FIG. 12. FIG. 12 is a cross-sectional view schematically illustrating a configuration of a thermal expansion layer-coated resin sheet which is a material of the three-dimensional object according to the modification example of the first embodiment of the present invention.

The thermal expansion layer-coated resin sheet 10C includes the ink reception layer 4 coating on the back surface of the base material 1 as illustrated in FIG. 12 to enable printing on the back surface. The thermal expansion layer-coated resin sheet 10C is formed by sequentially laminating the ink reception layer 4, the base material 1, the thermal expansion layer 2, and the ink reception layer 4. The constituent elements of the thermal expansion layer-coated resin sheet 10C are as described in relation to the above embodiment. However, in the modification example, when to be colored, a pigment other than black (not containing carbon black) is applied to the base material 1. In addition, the thermal deformation temperature T_{D} of the base material 1 may be higher than the expansion start temperature T_{Es} within the expansion temperature range of the thermal expansion layer 2.

(Method for Manufacturing the Sheet Formed Article)

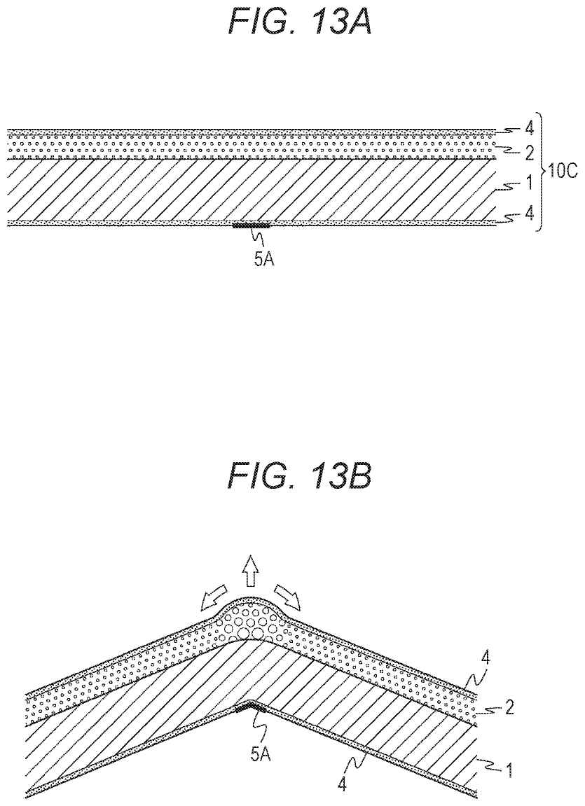

A method for manufacturing the sheet formed article according to the present modification example will be described with reference to FIGS. 13A and 13B, and FIG. 7 as appropriate. FIGS. 13A and 13B are schematic views illustrating the three-dimensional object manufacturing method according to the modification example of the first embodiment of the present invention. FIG. 13A is a cross-sectional view in a printing step, and FIG. 13B is a cross-sectional view in a light irradiation step. According to the method for manufacturing the sheet formed article according to the present modification example, the thermal expansion layer-coated resin sheet manufacturing step S10 of manufacturing the thermal expansion layer-coated resin sheet 10C, the printing step S21, the cutting step S23, and the light irradiation step S24 are sequentially performed (see FIG. 7). Moreover, in the thermal expansion layer-coated resin sheet manufacturing step S10, the release layer formation step S12 of the step S10 in the above embodiment is not performed but the ink reception layer formation step S13 is performed on both sides. Alternatively, the formation of the ink reception layer 4 may be formed on the back surface of the base material 1, and then the thermal expansion layer 2 may be formed on the front surface of the base material 1. Furthermore, the steps different from those in the above embodiment will be described in detail.

In the printing step S21, as illustrated in FIG. 13A, photothermal conversion members 5A are linearly printed in black ink on the ink reception layer 4 on the back surface of the thermal expansion layer-coated resin sheet 10C. Each of the photothermal conversion members 5A is a black pattern formed linearly on the back surface of the thermal expansion layer-coated resin sheet 10C. In the subsequent light irradiation step S24, the thermal expansion layer-coated resin sheet 10C is bent with the front surface oriented outward as in the above embodiment, and thus the photothermal conversion member 5A corresponds to a valley fold line. In other respects, the photothermal conversion member 5A is substantially the same in configuration as the photothermal conversion member 5 in the above embodiment, and may have an outline printed to serve as a cutting line in the cutting step S23. However, in the light irradiation step S24, the thermal expansion layer 2 expands in an area widened to a certain degree in the line-width direction immediately above the photothermal conversion member 5A, and thus the line width of the photothermal conversion member 5A is preferably designed to be thin as far as the area of the base material 1 to be heated is ensured.

In the light irradiation step S24, the surface (back surface) of the cut thermal expansion layer-coated resin sheet 10C cut in the cutting step S23 and on which the photothermal conversion members 5A are printed is irradiated with light by the light irradiation device 7 (7A). Then, the photothermal conversion member 5A generates heat to heat the base material 1, and the heat further propagates through the base material 1 in the thickness direction to heat the thermal expansion layer 2. As a result, as illustrated in FIG. 13B, the thermal expansion layer 2 expands immediately above and in the vicinity of the photothermal conversion member 5A, the base material 1 plastically deforms, and the thermal expansion layer-coated resin sheet 10C is folded to be bent toward the base material 1 to the both sides of the line (the photothermal conversion member 5A). In the present modification example, since the photothermal conversion member 5A serving as a heat source is provided closer to the base material 1, the base material 1 is heated earlier than the thermal expansion layer 2. Therefore, the base material 1 is likely to reach the thermal deformation temperature T_{D} before the thermal expansion layer 2 reaches the expansion start temperature T_{Es}. In particular, even when the base material 1 is thick, the base material 1 is likely to be entirely heated exceeding the thermal deformation temperature T_{D} in the thickness direction and be plastically deform. On the other hand, in comparison with the above embodiments, this tendency is stronger when the time during which the thermal expansion layer 2 is at the expansion start temperature T_{Es} or more, that is, the time during which the expansion progresses, is short with respect to the light irradiation time, and the base material 1 is thicker. Therefore, to fully expand the thermal expansion layer 2, the black density and line width of the photothermal conversion member 5A, or the output of the light irradiation device 7 are preferably set such that the photothermal conversion member 5A generates heat in a short time.

In the present modification example, in the case of using the light irradiation device 7, the thermal expansion layer-coated resin sheet 10C is processed with the back surface (printed surface) oriented upward, so that the ridge lines form valley folds with ends lifted. On the other hand, in the case of using the light irradiation device 7A, the thermal expansion layer-coated resin sheet 10C is processed with the back surface oriented downward, and the ridge lines form mountain folds with ends lifted.

Since the thermal expansion layer-coated resin sheet 10C includes the ink reception layer 4 coating the front surface (on the thermal expansion layer 2), the photothermal conversion member 5 may be printed on the front surface as in the above embodiment. Manufacturing the sheet formed article 11 from the thermal expansion layer-coated resin sheet 10C makes it possible to attach black lines to any one of the outer surface and the inner surface, that is, not to attach the lines to the desired surface. Alternatively, the thermal expansion layer-coated resin sheet 10C may include the ink reception layer 4 covering only the back surface for printing on the back surface. Further, the thermal expansion layer-coated resin sheet 10C may include the release layer 31 (see FIG. 4) between the ink reception layer 4 and the base material 1 and the ink removal step S25 may be performed after the light irradiation step S24 to manufacture the sheet formed article 11 in which no black lines are attached to the inner surface. The release layer 31 in the present modification example can be formed, for example, by thermocompression-bonding of a resin film to the base material 1.

### Second Embodiment

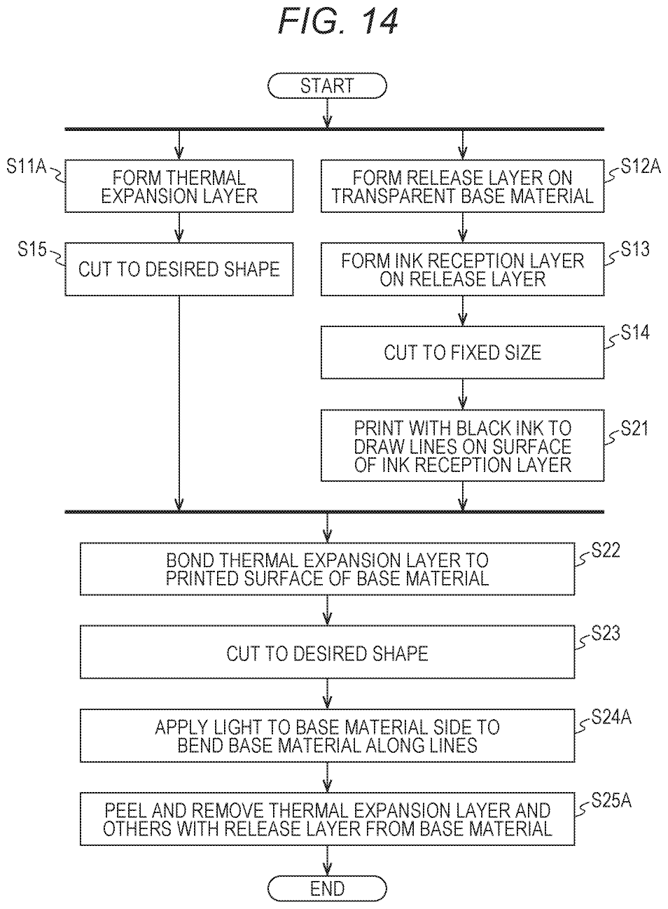

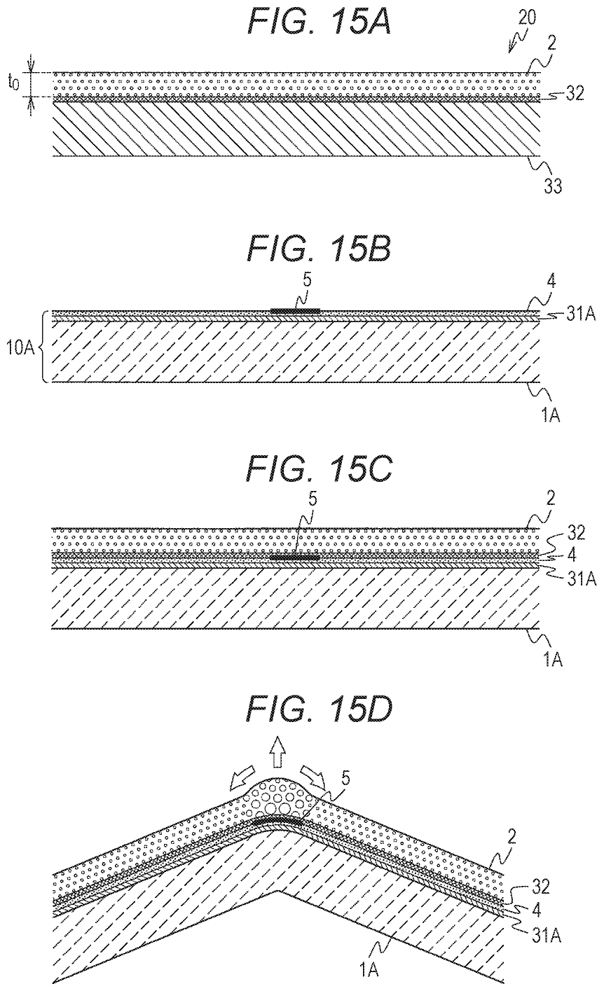

In the three-dimensional object according to the first embodiment, the two layers, that is, the thermal expansion layer and the base material are heated with the linear photothermal conversion member printed on one surface of the thermal expansion layer-coated resin sheet. Accordingly, there is the need to heat these two layers to their respective appropriate temperatures at appropriate timings only in the area on the lines (the photothermal conversion members) to bend the thermal expansion layer-coated resin sheet. Therefore, it is difficult to thicken the layers, especially the base material. Thus, a light-transmissive member to the base material so that the layers can be easily heated appropriately. Hereinafter, a three-dimensional object according to a second embodiment of the present invention will be described together with a method for manufacturing the same, with reference to FIGS. 14 and 15A to 15D, and as appropriate with reference to FIGS. 1A, 1B, 2A, 2B, and 10. FIG. 14 is a flow chart of the three-dimensional object manufacturing method according to the second embodiment of the present invention. FIGS. 15A to 15D are schematic diagrams illustrating the three-dimensional object manufacturing method according to the second embodiment of the present invention. FIG. 15A is a cross-sectional view in a thermal expansion layer formation step, FIG. 15B is a cross-sectional view in a printing step, FIG. 15C is a cross-sectional view in a bonding step, and FIG. 15D is a cross-sectional view in a light irradiation step. The same elements as those of the above embodiments (see FIGS. 1 to 11) will be denoted by the same reference numerals and description thereof will be omitted.

The sheet formed article (three-dimensional object) 11A according to the second embodiment of the present invention is a box illustrated in FIG. 1A or 2A, similarly to the sheet formed article 11 or the sheet formed article 12 according to the first embodiment. The sheet formed article 11A is formed only from the bent base material 1A as illustrated in FIG. 10 as in the modification example of the first embodiment. The sheet formed article 11A is manufactured from a thermal expansion film 20 and a resin sheet 10A illustrated in FIGS. 15A and 15B.

The resin sheet 10A is a printed material on which the photothermal conversion member 5 is printed in black ink. As illustrated in FIG. 15B, the resin sheet 10A includes the ink reception layer 4 coating the front surface (upper surface) so that the base material 1A can be printed, and further includes a release layer 31A between the ink reception layer 4 and the base material 1A. The resin sheet 10A merely needs to have dimensions equal to or larger than the developed shape of the sheet formed article 11A (see FIGS. 1B and 2B) as with the thermal expansion layer-coated resin sheet 10 in the first embodiment. The dimensions correspond to the size of a printing machine for forming the photothermal conversion member 5 at the manufacture of the sheet formed article 11A. The thermal expansion film 20 is a film-like member that enables the thermal expansion layer 2 to be easily laminated on the base material 1A (resin sheet 10A) at the manufacture of the sheet formed article 11A. The thermal expansion film 20 is formed by laminating the thermal expansion layer 2 and an adhesive layer 32, and is supported by bonding the adhesive layer 32 side to release paper 33. The thermal expansion film 20 merely needs to have dimensions equal to or larger than the developed shape of the sheet formed article 11A, which is equal to or smaller than the resin sheet 10A.

The base material 1A is broadly the same in configuration as the base material 1 in the first embodiment. However, the base material 1A is structured to sufficiently transmit light. When the base material 1A is to be colored, the amount of a pigment for the base material 1A is preferably suppressed as well as the thickness of the base material 1A. The base material 1A does not contain a black pigment. The release layer 31A is provided to remove the ink reception layer 4 and the thermal expansion layer 2 laminated thereon from the bent base material 1A (sheet formed article 11A) in the manufacturing process of the sheet formed article 11A. The release layer 31A is the same in configuration as the modification example of the first embodiment (see FIG. 11). The configurations of the thermal expansion layer 2 and the ink reception layer 4 are as described in relation to the above first embodiment. The adhesive layer 32 is an adhesive that bonds the ink reception layer 4 and the thermal expansion layer 2 on the surface of the resin sheet 10A, and is selected from known adhesives. Therefore, the adhesive layer 32 is an adhesive that has excellent adhesion between the ink reception layer 4 and the thermal expansion layer 2, which is at least higher than the adhesion between the release layer 31A and the base material 1A, and maintains the adhesion even at a heating temperature at which the base material 1A and the thermal expansion layer 2 are plastically deformed and expanded, and has flexibility that does not prevent the bending of the base material 1A and the like. The adhesive layer 32 is preferably formed with a thickness of about 1 to 20 μm, and more preferably less than 10 μm, so as not to inhibit the propagation of heat from the photothermal conversion member 5 to the thermal expansion layer 2. The release paper 33 is provided on the back surface of the thermal expansion film 20 to cover the adhesive layer 32 and support the soft thermal expansion layer 2. The release paper 33 is a film-like member that is peelable from the adhesive layer 32 because it is to be removed in the manufacturing process of the sheet formed article 11A. The release paper 33 can be general double-sided tape release paper. That is, the adhesive layer 32 and the release paper 33 can a double-sided tape in combination.

(Method for Manufacturing the Sheet Formed Article)

In the method for manufacturing the sheet formed article according to the present embodiment, as illustrated in FIG. 14, a thermal expansion layer formation step S11A of manufacturing the thermal expansion film 20, and steps S12A, S13, and S14 of manufacturing the resin sheet 10A, and a printing step S21 are individually performed, and a bonding step S22 of bonding the resin sheet 10A and the thermal expansion film 20, a cutting step S23, a light irradiation step S24A, and a thermal expansion layer removal step S25A are sequentially performed. Moreover, a cutting step S15 of cutting the thermal expansion film 20 as needed is performed after the thermal expansion layer formation step S11A and before the bonding step S22. In the manufacture of the sheet formed article according to the present embodiment, the devices used for manufacturing the sheet formed article according to the first embodiment can be used.

In the thermal expansion layer formation step S11A, as illustrated in FIG. 15A, slurry is applied onto the adhesive layer 32 on the release paper 33 to form the thermal expansion layer 2, thereby obtaining the thermal expansion film 20. The thermal expansion layer formation step S11A is the same as the thermal expansion layer formation step S11 of the first embodiment except that the base to be formed is different. Alternatively, the thermal expansion layer 2 may be formed on other release paper or the like, and the adhesive layer 32 be applied to the thermal expansion layer 2, and then the thermal expansion layer 2 be bonded to the release paper 33. In the cutting step S15, the obtained thermal expansion film 20 is cut out into a shape adapted to the developed shape of the resin sheet 10A or the sheet formed article 11A.

In the release layer formation step S12A, the release layer 31A is formed on the base material 1A (see FIG. 15B). For example, the resin film constituting the release layer 31A and the base material 1A are stacked and thermocompression-bonded. Then, in the ink reception layer formation step S13, the ink reception layer 4 is formed on the release layer 31A (see FIG. 15B). In the cutting step S14, the base material 1A on which the release layer 31A and the ink reception layer 4 are formed is cut into a predetermined dimension to obtain the resin sheet 10A.

In the printing step S21, as illustrated in FIG. 15B, the photothermal conversion members 5 are linearly printed in black ink on the ink reception layer 4 on the front surface of the resin sheet 10A. The configuration of the photothermal conversion members 5 is as described above in relation to the first embodiment, and the resin sheet 10A is bent with the printed surface oriented outward in the subsequent light irradiation step S24A. Thus, the photothermal conversion members 5 correspond to mountain fold lines. In addition, an outline to be a cutting line in the cutting step S23 may be printed.

In the bonding step S22, as illustrated in FIG. 15C, the release paper 33 is peeled off from the thermal expansion film 20, and the thermal expansion film 20 is bonded to the surface (printed surface) of the resin sheet 10A with the adhesive layer 32. At this time, the thermal expansion film 20 is bonded to the resin sheet 10A so as to completely cover the area constituting the sheet formed article 11A. Then, in the cutting step S23, the resin sheet 10A and the thermal expansion film 20 bonded together (laminated body) are cut out into the developed shape of the sheet formed article 11A.

In the light irradiation step S24A, the cut laminated body of the resin sheet 10A and the thermal expansion film 20 is irradiated with light by the light irradiation device 7 (7A) applied to the surface of the resin sheet 10A side (the back surface of the base material 1A). When light passes through the base material 1A and enters the photothermal conversion members 5, the photothermal conversion members 5 generate heat to heat the upper and lower thermal expansion layer 2 and the base material 1A. Then, the laminated body is folded and bent from both sides of the lines (the photothermal conversion members 5) toward the base material 1A as illustrated in FIG. 15D. In the present embodiment, the photothermal conversion members 5 serving as a heat source are provided between the thermal expansion layer 2 and the base material 1A. Accordingly, the heat propagates in both the upper and lower directions with high thermal efficiency so that the thermal expansion layer 2 and the base material 1A can be heated in parallel. Therefore, the base material 1A is likely to reach the thermal deformation temperature T_{D} before the thermal expansion layer 2 reaches the expansion start temperature T_{Es}. In particular, even when the base material 1A is thick, the base material 1A is likely to be entirely heated exceeding the thermal deformation temperature T_{D} in the thickness direction and be plastically deform. Furthermore, since the propagation distance of heat in the thickness direction is short, the heated areas of the thermal expansion layer 2 and the base material 1A are difficult to spread from the photothermal conversion members 5 in the line width direction. In particular, the expansion area of the thermal expansion layer 2 is easy to control, thereby suppressing the roundness of the ridge lines of the base material 1A.

In the present embodiment, in the case of using the light irradiation device 7, the laminated body is processed with the surface of the resin sheet 10A side (the back surface of the base material 1A) oriented upward, so that the ridge lines form valley folds with ends lifted. On the other hand, in the case of using the light irradiation device 7A, the laminated body is processed with the surface of the resin sheet 10A side oriented downward, and the ridge lines are lifted to form mountain folds.

In the thermal expansion layer removal step S25A, the thermal expansion film 20 bonded to the surface is peeled off from the bent resin sheet 10A. Both the ink reception layer 4 and the release layer 31A of the resin sheet 10A are removed by the adhesive layer 32 of the thermal expansion film 20, thereby to obtain the sheet formed article 11A made only of the bent base material 1A.

### Modification Example

In the present embodiment, the thermal expansion film 20 may not include the adhesive layer 32 so that the thermal expansion film 20 and the resin sheet 10A are bonded together by the adhesive (the adhesive layer 32) in the bonding step S22.

In the present embodiment, the photothermal conversion members 5 may be printed on the thermal expansion film 20. For this purpose, in the thermal expansion layer formation step S11A, the thermal expansion layer 2 is applied to release paper or the like to form the ink reception layer 4 on the thermal expansion layer 2, and then the thermal expansion layer 2 is cut to dimensions corresponding to the printing machine, thereby to obtain the thermal expansion film 20. The photothermal conversion members 5 are formed on the ink reception layer 4 of the thermal expansion film 20. Then, the base material 1A is bonded to the printed surface of the thermal expansion film 20 (bonding step S22), and the release paper is peeled off to expose the thermal expansion layer 2 to the surface. At this time, the base material 1A and the thermal expansion film 20 may be bonded using the release layer 31A such as an adhesive, or may be bonded by thermocompression bonding at a temperature lower than the expansion start temperature T_{Es} of the thermal expansion layer 2. Thereafter, as in the foregoing embodiments, the cutting step S23, the light irradiation step S24A, and the thermal expansion layer removal step S25A are sequentially performed.

In the present embodiment, the sheet formed article 11 (see FIG. 3) of which outer surface is coated with the thermal expansion layer 2 can also be manufactured. That is, since the thermal expansion layer removal step S25A is not performed and the release layer 31A is not necessary, the ink reception layer 4 is formed directly on the base material 1A (or the thermal expansion film 20) without performing the release layer formation step S12A. Although the sheet formed article 11 according to the modification example is coated with the thermal expansion layer 2 with the black lines (the photothermal conversion members 5) expanded. Appearance-wise, the black lines are hard to visually recognize on the ridge lines, although depending on the thickness of the thermal expansion layer 2 and the black density and line width of the photothermal conversion members 5. In addition, the black lines on the inner surface are also hard to visually recognize depending on the color of the base material 1A.

In the sheet formed article 11A according to the present embodiment, the thermal expansion layer 2, that is, the thermal expansion film 20 may not be provided on the entire surface in the manufacturing process, as long as the thermal expansion film 20 covers at least the photothermal conversion members 5. The thermal expansion film 20 preferably covers the photothermal conversion members 5 up to the thickness of the base material 1A or more on both outer sides of the lines as seen in the line width direction (and up to the initial thickness to of the thermal expansion layer 2). Moreover, the thermal expansion film 20 preferably has a certain degree of width or more to ensure the adhesiveness with the resin sheet 10A. Therefore, the thermal expansion film 20 is cut out in a strip shape in the cutting step S15. The strip-shaped thermal expansion film 20 is attached to the resin sheet 10A along the printed black lines (the photothermal conversion members 5) in the bonding step S22. Alternatively, the photothermal conversion members 5 may be printed on the thermal expansion film 20, and the thermal expansion film 20 be cut out in a strip shape such that the photothermal conversion members 5 become center lines, and the printed surface of the thermal expansion film 20 be attached to the portions of the base material 1A to be bent.

### Third Embodiment

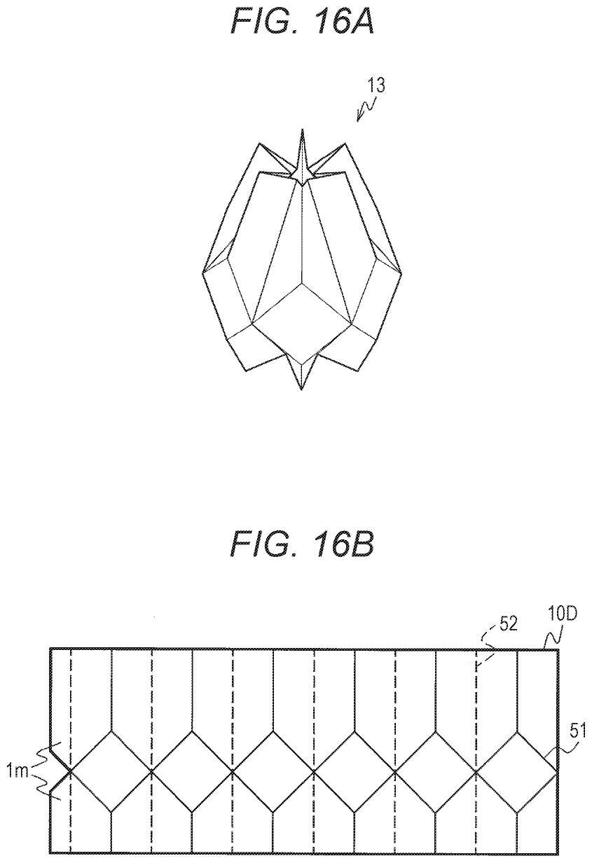

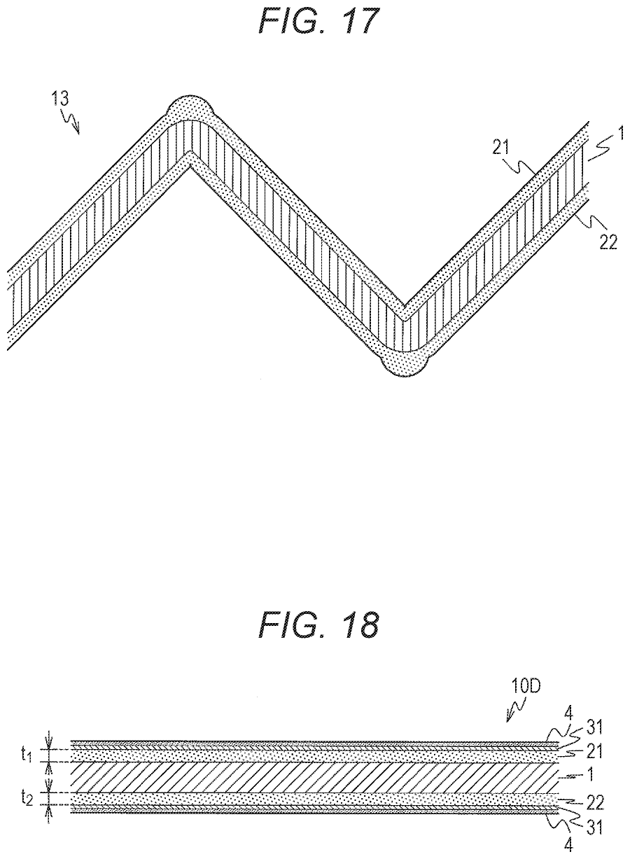

Each of the three-dimensional objects according to the first and second embodiments and their modification examples is bent with the surface of the base material coated with the thermal expansion layer oriented outward, and thus the three-dimensional object has a three-dimensional shape formed from mountain folds only (or valley folds only). Therefore, both the surfaces of a base material are covered with a thermal expansion layer so that a three-dimensional object has a mixture of mountain folds and valley folds. Hereinafter, a three-dimensional object according to a third embodiment of the present invention will be described with reference to FIGS. 16A, 16B, and 17. FIG. 16A is an external view of a three-dimensional object according to the present invention, and FIG. 16B is a developed view of the three-dimensional object. FIG. 17 is a partial cross-sectional view schematically illustrating a configuration of a three-dimensional object according to a third embodiment of the present invention. The same elements as those of the above embodiments (see FIGS. 1 to 13) will be denoted by the same reference numerals and description thereof will be omitted.

(Sheet Formed Article)

As illustrated in FIG. 16A, the sheet formed article (three-dimensional object) 13 has a cylindrical body with upper and lower narrowed ends in which six squares with diagonals oriented in the vertical direction are connected at the vertexes and horizontally arranged in a ring and the upper and lower sides are folded in a bellows shape. The sheet formed article can be a decorative item such as a lamp shade, for example. The sheet formed article 13 is assembled by folding a rectangular flat sheet illustrated in FIG. 16B along mountain fold lines illustrated by solid lines (photothermal conversion members 51) and valley fold lines illustrated by broken lines (photothermal conversion members 52) and connecting the right and left sides with an overlap margin 1m as a gluing margin into a cylindrical body.

The sheet formed article 13 according to the third embodiment of the present invention includes a base material 1 and thermal expansion layers 21 and 22 laminated on the both surfaces of the base material 1 as illustrated in FIG. 17. The thermal expansion layer 21 or the thermal expansion layer 22 covering the outer surfaces is expanded from the ridge lines. The sheet formed article 13 according to the present embodiment is manufactured from a thermal expansion layer-coated resin sheet 10D illustrated in FIG. 18.

(Thermal Expansion Layer-Coated Resin Sheet)

A configuration of the thermal expansion layer-coated resin sheet 10D before the formation of the sheet formed article 13 will be described below with reference to FIG. 18. FIG. 18 is a cross-sectional view schematically illustrating a configuration of a thermal expansion layer-coated resin sheet which is a material of the three-dimensional object according to the third embodiment of the present invention. The thermal expansion layer-coated resin sheet 10D is a flat member having a uniform thickness, and is formed by laminating the first thermal expansion layer 21 on one surface of the base material 1 and the second thermal expansion layer 22 on the other surface, and sequentially laminating a release layer 31 and an ink reception layer 4 on the both side surfaces of the base material 1. The thermal expansion layer-coated resin sheet 10D is a printed material on which the photothermal conversion members 51 and 52 are printed in black ink on the both surfaces, that is, on the ink reception layers 4 and 4. Therefore, as with the thermal expansion layer-coated resin sheet 10 in the first embodiment, the thermal expansion layer-coated resin sheet 10D has a dimension (a fixed size) corresponding to a printing machine for forming the photothermal conversion members 51 and 52 at the manufacture of the sheet formed article 13. The size is larger than the developed shape of the sheet formed article 13 (see FIG. 16B), for example, the A3 size.

The configurations of the base material 1, the release layer 31, and the ink reception layer 4 are as described above in relation to the first embodiment. The first thermal expansion layer 21 and the second thermal expansion layer 22 (hereinafter, called collectively the thermal expansion layers 21 and 22 as appropriate) have the same configuration as the thermal expansion layer 2 of the first embodiment. The first thermal expansion layer 21 and the second thermal expansion layer 22 have the same material and initial thicknesses t₁ and t₂ (t₁=t₂). The thermal deformation temperature T_{D} of the thermoplastic resin constituting the base material 1 is preferably equal to or lower than the expansion start temperature T_{Es}, and more preferably lower than the expansion start temperature T_{Es}. When the initial thicknesses t₁ and t₂ of the thermal expansion layers 21 and 22 are large, as described in relation to the first embodiment, the load acting on the base material 1 due to expansion becomes high in the manufacturing process of the sheet formed article 13. On the other hand, when the thermal expansion layer-coated resin sheet 10D bends, the thermal expansion layer 22 (21) on the inner side is folded tightly (with a high curvature). Due to its elasticity, the thermal expansion layer-coated resin sheet 10D is hard to bend, which inhibits plastic deformation of the base material 1. Specifically, the initial thicknesses t₁ and t₂ of the thermal expansion layers 21 and 22 are preferably 50 to 100 μm. Furthermore, the initial thicknesses t₁ and t₂ are preferably designed such that both the load due to the expansion of the outer thermal expansion layer 21 (22) and the interference by the thermal expansion layer 22 (21) with the inner non-expansion thickness t₂ (t₁) are appropriate.

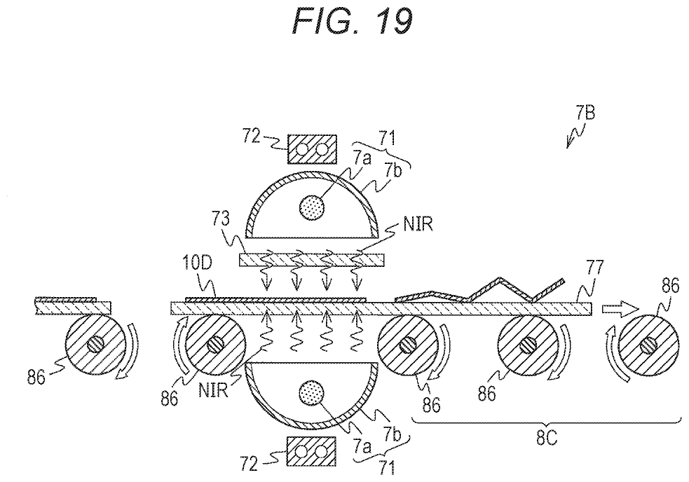

(Manufacturing Devices) Devices used for manufacturing the sheet formed article according to the present embodiment will be briefly described. As in the manufacture of the thermal expansion layer-coated resin sheet 10 of the first embodiment, a coating device and a cutting machine are used in the manufacture of the thermal expansion layer-coated resin sheet 10D as a material of the sheet formed article 13 (not illustrated in the figures). In the manufacture of the sheet formed article 13, a printing machine to print the photothermal conversion members 51 and 52 in black ink on both sides of the thermal expansion layer-coated resin sheet 10D, and a processing tool to cut the thermal expansion layer-coated resin sheet 10D into the developed shape of the sheet formed article 13 (not illustrated) as described above in relation to the first embodiment. Furthermore, in the present embodiment, a light irradiation device 7B (see FIG. 19) is used to simultaneously apply near infrared rays to both surfaces of the thermal expansion layer-coated resin sheet 10D. Hereinafter, the light irradiation device will be briefly described with reference to FIG. 19. FIG. 19 is a cross-sectional view illustrating an outline of the light irradiation device used for manufacturing a three-dimensional object.

As illustrated in FIG. 19, the light irradiation device 7B includes two light irradiation units 71 and two coolers 72, and further includes a protection plate 73, a stage 77, and a transport mechanism 8C. The light irradiation units 71, the coolers 72, and the protection plate 73 have the same configurations as those of the light irradiation device 7 (see FIG. 5) used in the first and second embodiments. The light irradiation device 7B is configured such that the light irradiation units 71 and the coolers 72 vertically reversed as in the light irradiation device 7A (see FIG. 6) and the stage 77 are added to the light irradiation device 7 that applies light to the upper surface of an object to be processed. Further, the light irradiation device 7B includes the transport mechanism 8C instead of the transport mechanism 8. The stage 77 is a flat plate-like member on which an object to be processed is to be placed, and is transported by the transport mechanism 8C together with the object to be processed. The stage 77 has a high light transmittance so that the light from the lower light irradiation unit 71 can be applied to the lower surface of the object to be processed. The stage 77 is made of a material with a high thermal conductivity, as with the belt 81 in the light irradiation device 7, for example, a glass plate. The light irradiation device 7B is preferably configured such that the two light irradiation units 71 and 71 are opposed to each other with a coincidence of the light irradiation areas, and the amounts of light passing through the protection plate 73 or the stage 77 and entering the upper surface and lower surface of the object to be processed are equal.

The transport mechanism 8C transports the stage 77 together with the object to be processed thereon at a constant speed in one horizontal direction, without blocking the light from the lower light irradiation unit 71. The transport mechanism 8C is a roller conveyor, for example, which includes a plurality of carrier rollers 86, 86, . . . , arranged in the transport direction and a motor and a transmission mechanism such as a belt or a chain (not illustrated) for rotationally driving the carrier rollers 86 at the same rotational speed (circumferential speed). The carrier rollers 86 are disposed avoiding the light irradiation area (immediately above the lower light irradiation unit 71). Alternatively, the transport mechanism 8C can be configured by a belt conveyor as the transport mechanism 8 of the light irradiation device 7. However, two belts are provided at both ends (both edges) in the transport-width direction so as not to block the light from the light irradiation units 71, and the stage 77 is bridged between the belts. Alternatively, as described above in relation to the first embodiment, the object to be processed can be placed directly on the transport mechanism 8 with the belt 81 (see FIG. 5) as a light-transmissive member without using the stage 77. Alternatively, the transport mechanism 8C may be a known linear motion mechanism such as a rack and pinion gear system or a ball screw system, which is disposed avoiding the light irradiation area and connected at the edge to the stage 77.

The light irradiation device 7B can also include a transport mechanism 8A configured by a sheet loader as in the light irradiation device 7A of the first embodiment (see FIG. 6). In the light irradiation device 7B, the main transport roller 84 is disposed in the vicinity of the rear side of the light irradiation area.

(Method for Manufacturing the Sheet Formed Article)

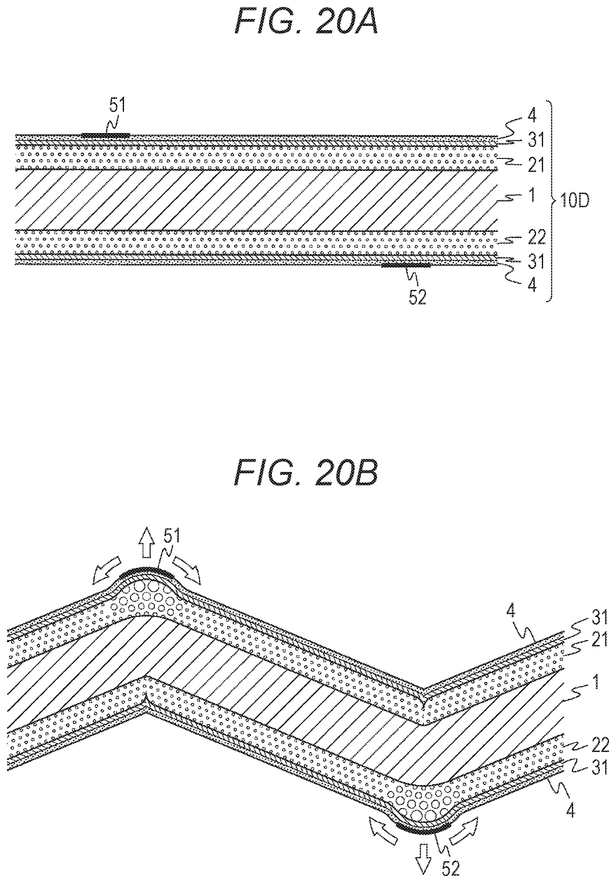

A method for manufacturing the sheet formed article according to the third embodiment will be described with reference to FIGS. 7, 20A, and 20B, and FIGS. 16 to 19 as appropriate. FIGS. 20A and 20B are schematic views illustrating the three-dimensional object manufacturing method according to the third embodiment of the present invention. FIG. 20A is a cross-sectional view in a printing step, and FIG. 20B is a cross-sectional view in a light irradiation step. As illustrated in FIG. 7, in the method for manufacturing the sheet formed article according to the present embodiment, a thermal expansion layer-coated resin sheet manufacturing step S10 of manufacturing the thermal expansion layer-coated resin sheet 10D, a printing step S21, a cutting step S23, a light irradiation step S24, and an ink removal step S25 are sequentially performed. In the thermal expansion layer-coated resin sheet manufacturing step S10, as in the first embodiment, a thermal expansion layer formation step S11, a release layer formation step S12, and an ink reception layer formation step S13 are sequentially performed. However, these steps are performed on both surfaces of the base material. Then, a cutting step S14 is performed if necessary.

In the thermal expansion layer formation step S11, the first thermal expansion layer 21 is formed on one surface (upper side) of the base material 1, and the second thermal expansion layer 22 is formed on the other surface (lower side) with their respective thicknesses t₁ and t₂ (t₁=t₂). The formation method of the thermal expansion layers 21 and 22 is the same as the thermal expansion layer formation step S11 of the first embodiment. Then, in the release layer formation step S12, the release layer 31 is formed on each of the thermal expansion layers 21 and 22. Then, in the ink reception layer formation step S13, the ink reception layer 4 is formed on each of the release layers 31 and 31 on both sides. For example, after sequential formation of the first thermal expansion layer 21, the release layer 31, and the ink reception layer 4 on one surface of the base material 1, the second thermal expansion layer 22, the release layer 31, and the ink reception layer 4 may be sequentially formed on the other surface of the base material 1. In the cutting step S14, as in the first embodiment, the base material 1 on which the thermal expansion layers 21 and 22 and others are formed is cut, thereby to obtain the thermal expansion layer-coated resin sheet 10D having a dimension corresponding to a printing machine used in the subsequent printing step S21 (see FIG. 18).

In the printing step S21, as illustrated in FIGS. 20A and 16B, the photothermal conversion members 51 and 52 are linearly printed in black ink on the ink reception layers 4 and 4 on the both surfaces of the thermal expansion layer-coated resin sheet 10D. The photothermal conversion members 51 and 52 are formed at locations where to form mountain fold lines on the respective printing surfaces. The photothermal conversion member 51 on one surface side and the photothermal conversion member 52 on the other surface side of the thermal expansion layer-coated resin sheet 10D have the same configuration as the photothermal conversion member 5 of the first embodiment. When the amounts of light applied by the light irradiation device 7B to both sides are equal, the photothermal conversion member 51 and the photothermal conversion member 52 are printed with the same black density so as to generate heat to the same temperature in the subsequent light irradiation step S24. In addition, preferably, the photothermal conversion member 51 or the photothermal conversion member 52 are not formed in the location where the mountain fold line and the valley fold line (the photothermal conversion member 51 and the photothermal conversion member 52) intersect or contact. When both of the photothermal conversion members 51 and 52 are formed in the same area in plan view, the thermal expansion layer-coated resin sheet 10D is excessively heated to a high temperature in the subsequent light irradiation step S24. In this case, there is a risk of overexpansion of the thermal expansion layers 21 and 22, holes in the base material 1, or the like. Further, as in the first embodiment, an outline (thick line in FIG. 16B) to be a cutting line in the cutting step S23 may be printed simultaneously with the photothermal conversion member 51 or the photothermal conversion member 52.

In the cutting step S23, the thermal expansion layer-coated resin sheet 10D on which the photothermal conversion members 51 and 52 are formed is cut out along the outline indicated by the thick line in FIG. 16B into a developed shape of the sheet formed article 13.

In the light irradiation step S24, the both surfaces of the cut thermal expansion layer-coated resin sheet 10D are irradiated with light by the light irradiation device 7B. The photothermal conversion member 51 generates heat due to the light from above to heat the first thermal expansion layer 21, and the heat further propagates from the surface of the first thermal expansion layer 21 in the thickness direction (downward) to heat the base material 1. In addition, the photothermal conversion member 52 generates heat due to light from below to heat the second thermal expansion layer 22, and the heat further propagates from the surface of the second thermal expansion layer 22 in the thickness direction (upward) to heat the base material 1. As a result, as illustrated in FIG. 20B, as in the first embodiment (see FIG. 8D), the first thermal expansion layer 21 expands immediately below the photothermal conversion member 51, the base material 1 plastically deforms, and the thermal expansion layer-coated resin sheet 10D is folded toward the second thermal expansion layer 22 on the both sides of the line (the (photothermal conversion member 51). Further, the second thermal expansion layer 22 expands immediately above the photothermal conversion member 52, the base material 1 plastically deforms, and the thermal expansion layer-coated resin sheet 10D is folded toward the first thermal expansion layer 21 on the both sides of the line (the photothermal conversion member 52). After the application of the light to the thermal expansion layer-coated resin sheet 10D is stopped, the base material 1 is cooled to less than the thermal deformation temperature T_{D}, whereby the deformation of the thermal expansion layer-coated resin sheet 10D is completed.

Here, immediately below the photothermal conversion member 51, the heat from the photothermal conversion member 51 sequentially propagates through the first thermal expansion layer 21 and the base material 1, and further propagates to the second thermal expansion layer 22. The heating temperature (maximum temperature) of the second thermal expansion layer 22 immediately below the photothermal conversion member 51 is lower than that of the first thermal expansion layer 21 such that, even when expanding due to the heating, the amount of the expansion of the second thermal expansion layer 22 is reduced to be smaller than that of the first thermal expansion layer 21. Ideally, it is preferable that the second thermal expansion layer 22 does not expand, that is, does not reach the expansion start temperature T_{Es} or higher of the thermal expansion layers 21 and 22. On the other hand, the expansion amount of the first thermal expansion layer 21 is preferably larger. Therefore, as described above in relation to the first embodiment, the heating temperature of the first thermal expansion layer 21 is preferably near a maximum expansion temperature T_{Emax} of the thermal expansion layers 21, 22. Similarly, immediately above the photothermal conversion member 52, the expansion amount of the first thermal expansion layer 21 is preferably smaller than that of the second thermal expansion layer 22, and the expansion amount of the second thermal expansion layer 22 is preferably larger. From these facts, as with the photothermal conversion member 5 of the first embodiment, t is preferable that the photothermal conversion members 51 and 52 be designed to have a black density so as to generate heat at a temperature near the maximum expansion temperature T_{Emax}. In the light irradiation step S24, after the photothermal conversion members 51 and 52 and the first thermal expansion layer 21 or the second thermal expansion layer 22 nearest the photothermal conversion members 51 and 52 reach the maximum temperature, it is preferred to stop the light irradiation immediately to naturally cool these components. Most preferably, the second thermal expansion layer 22 or the first thermal expansion layer 21 tardily increasing in temperature via the base material 1 is cooled without reaching the expansion start temperature T_{Es}. Therefore, the heating speed (the temperature rising speed of the photothermal conversion members 51 and 52) is preferably high, and the output and the conveyance speed of the light source 7a of the light irradiation device 7B are set such that this temperature transition takes place. In addition, materials and the like of the base material 1 and the thermal expansion layers 21 and 22 are selected such that the base material 1 is heated to the thermal deformation temperature T_{D} or more under such conditions.

In the ink removal step S25, as in the first embodiment, the ink reception layer 4 is peeled off with the release layer 31 from each of the both surfaces of the bent thermal expansion layer-coated resin sheet 10D, thereby to obtain the sheet formed article 13 illustrated in FIG. 17. The sheet formed article 13 is formed in a cylindrical shape by, with an overlap margin 1m (see FIG. 16B) as a gluing margin, bonding with an adhesive the front surface (the first thermal expansion layer 21) and the back surface of the end (the second thermal expansion layer 22) opposed to the overlap margin 1m, and then is adjusted in shape and completed as illustrated in FIG. 16A.

### Modification Example

In the sheet formed article 13, the photothermal conversion members 51 and 52 may remain on the both surfaces or one surface along the ridge lines depending on the application such as trial manufacture. In this case, the thermal expansion layer-coated resin sheet 10D may not have the release layer 31 on both surfaces or on one surface.

The sheet formed article 13 may be formed from only the bent base material 1 by peeling and removing the ink reception layer 4 together with the thermal expansion layers 21 and 22 therebelow in the ink removal step S25, as with the sheet formed article 11A according to the modification example of the first embodiment (see FIG. 10). Therefore, the thermal expansion layer-coated resin sheet 10D includes a release layer 31A between the base material 1 and the thermal expansion layers 21 and 22 instead of the release layer 31. The sheet formed article 13 can be manufactured in the same manner as the thermal expansion layer-coated resin sheet 10B (see FIG. 11) and the sheet formed article 11A in the modification example of the first embodiment. Alternatively, for example, the sheet formed article 13 can be manufactured such that the release layer 31A is provided only between the second thermal expansion layer 22 and the base material 1, the first thermal expansion layer 21 is provided on one surface, and the base material 1 is exposed on the other surface (not illustrated).

The sheet formed article 13 can be manufactured by applying light to each of the surfaces of the thermal expansion layer-coated resin sheet 10D using the light irradiation device 7A (see FIG. 6) in the light irradiation step S24 as far as the base material 1 is of low rigidity due to its softness or thinness and there is no risk of the base material 1 becoming broken even when the bent fold line is stretched by external force and returned to a flat state or is bent and folded again. That is, after the first light irradiation, the bent thermal expansion layer-coated resin sheet 10D is returned to be flat, and the second light irradiation is performed.

In the printing step S21, as illustrated in FIG. 21, low-black density (light) lines (hereinafter, called gray lines) 521 and 511 may be printed on respective surfaces opposite to the photothermal conversion members 51 and 52 in the same areas in plan view. That is, the thermal expansion layer-coated resin sheet 10D has the high-black density lines (the photothermal conversion members 51 and 52) and the gray lines 521 and 511 formed on the both surfaces in the same region. The gray lines 521 and 511 are set to a black density at which the nearest first thermal expansion layer 21 or second thermal expansion layer 22 is heated to a temperature lower than the expansion start temperature T_{Es} in the light irradiation step S24. When is irradiated with light from both sides in the light irradiation step S24, the thermal expansion layer-coated resin sheet 10D is heated to some extent not only from the photothermal conversion members 51 and 52 but also from the opposite gray lines. Therefore, the base material 1 is efficiently heated to the thermal deformation temperature T_{D} or more, which is effective for the thick base material 1 in particular.

### Modification Example of the First Embodiment

The heating from the black lines and the gray lines printed on both surfaces using the light irradiation device 7B as in the modification example is also applicable to the manufacture of the sheet formed articles 11 and 11A according to the first embodiment and the modification example. That is, as in the thermal expansion layer-coated resin sheet 10C (see FIG. 12), the ink reception layer 4 is provided to allow printing on both surfaces, and in the printing step S21, the photothermal conversion members 5 are formed on the front surface, and the photothermal conversion members 5A are formed on the back surface in the same area in plan view. The black densities of the photothermal conversion members 5 and 5A are preferably set according to the thermal properties of the thermal expansion layer 2 and the base material 1. Accordingly, when light is applied from both sides in the light irradiation step S24, the thermal expansion layer 2 receives heat propagated from the photothermal conversion members 5 immediately above, and the base material 1 receives mainly heat from the photothermal conversion members 5A immediately below and also heat from the photothermal conversion members 5 immediately above through the thermal expansion layer 2. Thus, both the thermal expansion layer 2 and the base material 1 can be easily heated to their respective appropriate temperatures (the maximum expansion temperature T_{Emax} and the thermal deformation temperature T_{D} or more). As a result, the thermal expansion layer-coated resin sheet 10 (10B) can be suitably bent, which is effective particularly when the base material 1 is thick or when the thermal deformation temperature T_{D} is relatively high.

### Fourth Embodiment

The three-dimensional object according to the third embodiment and the modification example is manufactured by coating both surfaces of the base material with a thermal expansion layer to form a shape with a mixture of mountain folds and valley folds and applying light to both surfaces. However, the three-dimensional object can also be manufactured by applying light to only one surface. Hereinafter, a three-dimensional object manufacturing method according to a fourth embodiment of the present invention will be described. The same elements as those in the above embodiments (see FIGS. 1 to 20) are denoted by the same reference numerals, and description thereof will be omitted.

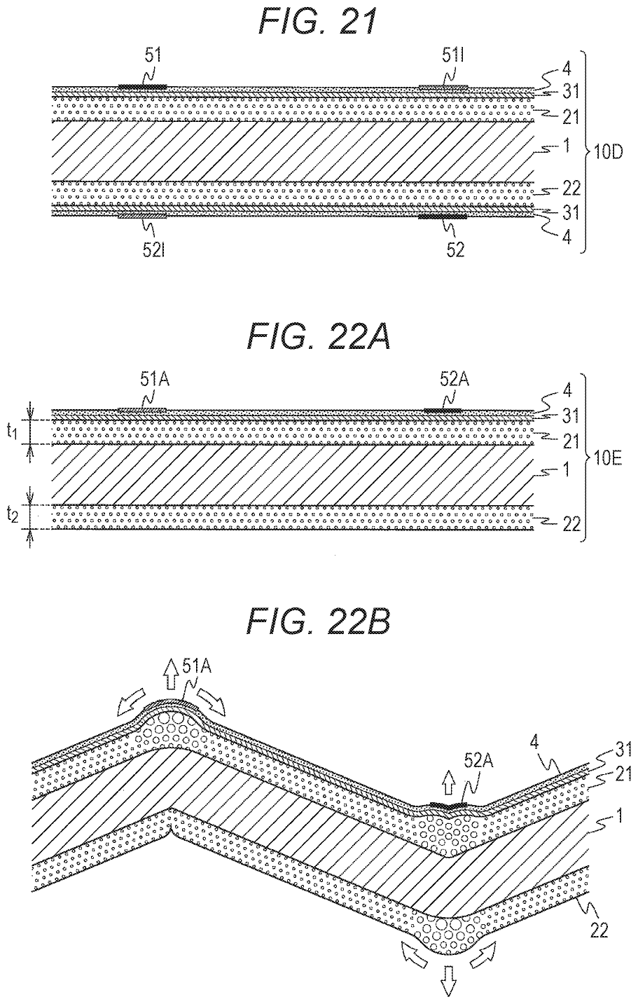

In the three-dimensional object manufacturing method according to the present embodiment, the sheet formed article (three-dimensional object) 13 obtained has the shape and the structure illustrated in FIGS. 16A, 16B, and 17 as in the third embodiment. On the other hand, in the present embodiment, the sheet formed article 13 may be manufactured from the thermal expansion layer-coated resin sheet 10D (see FIG. 18) as in the third embodiment. However, the sheet formed article 13 can be manufactured from a thermal expansion layer-coated resin sheet 10E including the ink reception layer 4 on the surface of one side (see FIG. 22A) because the photothermal conversion member is to be formed and irradiated with light only on one surface in the process of manufacture. Specifically, the thermal expansion layer-coated resin sheet 10E includes the release layer 31 and the ink reception layer 4 laminated only on the first thermal expansion layer 21, that is, the release layer 31 and the ink reception layer 4 on the second thermal expansion layer 22 are removed from the thermal expansion layer-coated resin sheet 10D. The elements are as described above in relation to the third embodiment.

(Method for Manufacturing the Sheet Formed Article)

A method for manufacturing the sheet formed article according to the present embodiment will be described with reference to FIGS. 7, 22A, and 22B, and FIGS. 16A and 16B as appropriate. FIGS. 22A and 22B are schematic views illustrating the three-dimensional object manufacturing method according to the fourth embodiment of the present invention. FIG. 22A is a cross-sectional view in a printing step, and FIG. 22B is a cross-sectional view in a light irradiation step. As illustrated in FIG. 7, in the method for manufacturing the sheet formed article according to the present embodiment, a thermal expansion layer-coated resin sheet manufacturing step S10 of manufacturing the thermal expansion layer-coated resin sheet 10E, a printing step S21, a cutting step S23, a light irradiation step S24, and an ink removal step S25 are sequentially performed. In the thermal expansion layer-coated resin sheet manufacturing step S10, as in the first embodiment, a thermal expansion layer formation step S11, a release layer formation step S12, and an ink reception layer formation step S13 are sequentially performed. After that, a cutting step S14 is performed as necessary. The thermal expansion layer formation step S11 is performed on the both surfaces of the base material. In the manufacture of the sheet formed article according to the present embodiment, the devices used for manufacturing the sheet formed article according to the first embodiment can be used.

In the thermal expansion layer formation step S11, as in the third embodiment, the first thermal expansion layer 21 is formed on one surface (upper side) of the base material 1, and the second thermal expansion layer 22 is formed on the other surface (lower side) with their respective thicknesses t₁ and t₂ (t₁=t₂). Then, in the release layer formation step S12, the release layer 31 is formed on the first thermal expansion layers 21. Then, in the ink reception layer formation step S13, the ink reception layer 4 is formed on the release layer 31. In the cutting step S14, as in the first embodiment, the base material 1 on which the thermal expansion layers 21 and 22 and others are formed is cut, thereby to obtain the thermal expansion layer-coated resin sheet 10E having a dimension corresponding to a printing machine used in the subsequent printing step S21 (see FIG. 22A).

In the printing step S21, as illustrated in FIGS. 22A and 16B, the photothermal conversion members 51A and 52A (the photothermal conversion members 51 and 52 in FIG. 16B) are linearly printed in black ink on the ink reception layer 4 on one surface of the thermal expansion layer-coated resin sheet 10E. On the printing surface (one surface side) of the thermal expansion layer-coated resin sheet 10E, the photothermal conversion members 51A are mountain fold lines, and the photothermal conversion members 52A are valley fold lines. The photothermal conversion members 51A and 52A have the same configuration as the photothermal conversion members 5 of the first embodiment, but the photothermal conversion members 51A are formed with a lower black density (lighter) than the photothermal conversion members 52A. This is because the photothermal conversion members 52A are to be heated to a higher temperature in the subsequent light irradiation step S24. As described later in detail in relation to the light irradiation step S24, the photothermal conversion members 51A are heated to the expansion start temperature T_{Es} or more, preferably around the maximum expansion temperature T_{Emax} because the photothermal conversion members 51A are to generate heat to expand the nearest first thermal expansion layer 21 immediately below, and the base material 1 is heated to the thermal deformation temperature T_{D} or more. On the other hand, the photothermal conversion members 52A generate heat to heat the nearest first thermal expansion layer 21 immediately below to a high temperature exceeding the maximum expansion temperature T_{Emax}, the base material 1 is heated to the thermal deformation temperature T_{D} or more, and the second thermal expansion layer 22 is heated to the expansion start temperature T_{Es} or more to expand. The photothermal conversion members 51A and 52A are set to their respective black densities so as to generate heat at the temperatures described above when irradiated with the same amount of light in the light irradiation step S24. Furthermore, since the second thermal expansion layer 22 expands in a region which spreads to some extent in the line width direction directly below the photothermal conversion members 52A, the photothermal conversion members 52A are preferably designed with a small line width within a range in which the heated area of the base material 1 is secured, similarly to the photothermal conversion members 5A in the modification example of the first embodiment. In addition, as in the first embodiment, an outline (thick line in FIG. 16B) to be a cutting line in the subsequent cutting step S23 may be printed together with the photothermal conversion members 51A and 52A.

In the cutting step S23, as in the third embodiment, the thermal expansion layer-coated resin sheet 10E on which the photothermal conversion members 51A and 52A are formed is cut out along the outline indicated by the thick line in FIG. 16B into a developed shape of the sheet formed article 13.

In the light irradiation step S24, the surface (one surface) of the cut thermal expansion layer-coated resin sheet 10E on which the photothermal conversion members 51A and 52A are printed is irradiated with light by the light irradiation device 7 (7A). Then, the photothermal conversion members 51A and 52A generate heat at temperatures corresponding to the respective black densities, and the heat sequentially propagates through the first thermal expansion layer 21, the base material 1, and the second thermal expansion layer 22. As illustrated in FIG. 22B, immediately below the photothermal conversion member 51A, as immediately below the photothermal conversion member 51 in the third embodiment (see FIG. 20B), the first thermal expansion layer 21 expands, the base material 1 plastically deforms, and the thermal expansion layer-coated resin sheet 10E is folded toward the second thermal expansion layer 22 on the both sides of the line (the photothermal conversion member 51A). Further, the second thermal expansion layer 22 has a lower maximum temperature than the first thermal expansion layer 21 and therefore has a small amount of expansion, and ideally does not reach the expansion start temperature T_{Es} and does not expand. On the other hand, in order to expand the first thermal expansion layer 21 more largely, the photothermal conversion member 51A is preferably designed to have a black density so as to generate heat at a temperature near the maximum expansion temperature T_{Emax}.

Further, immediately below the photothermal conversion member 52A, the base material 1 reaches the thermal deformation temperature T_{D} or more, and the second thermal expansion layer 22 reaches the expansion start temperature T_{Es} or more and expands. On the other hand, the first thermal expansion layer 21 nearest the photothermal conversion member 52A is heated to a higher temperature and exceeds the maximum expansion temperature T_{Emax}. In general, when the microcapsules are heated to a high temperature exceeding the maximum expansion temperature T_{Emax}, the contained volatile solvent diffuses through the shell at a high speed, so the expansion rate decreases, and the microcapsules shrink when they have already expanded. Therefore, immediately below the photothermal conversion member 52A, the first thermal expansion layer 21 has an expansion coefficient that is less than the maximum expansion coefficient, and further is lower than the expansion coefficient of the second thermal expansion layer 22. As a result, the second thermal expansion layer 22 has a larger expansion amount than the first thermal expansion layer 21 and has a high load acting on the base material 1. Accordingly, as illustrated in FIG. 22B, the thermal expansion layer-coated resin sheet 10E folds and bends toward the first thermal expansion layer 21 on the both sides of the line (the photothermal conversion member 52A). Also immediately below the photothermal conversion member 52A, the nearest first thermal expansion layer 21 is heated earlier to reach the expansion start temperature T_{Es}. However, when being heated at a high speed, before the first thermal expansion layer 21 expands and plastically deforms the base material 1, the first thermal expansion layer 21 reaches the maximum expansion temperature T_{Emax} to lower the expansion coefficient or the second thermal expansion layer 22 reaches a temperature with an expansion coefficient exceeding the first thermal expansion layer 21.

As described above, immediately below the photothermal conversion member 52A, the nearest first thermal expansion layer 21 preferably reaches a temperature (about T_{Es}+50 to 80° C.) that is higher than the maximum expansion temperatures T_{Emax} of the thermal expansion layers 21 and 22 at which the expansion coefficient is sufficiently lowered. For this end, the photothermal conversion member 52A is preferably designed to have a black density so as to generate heat at the high temperature described above exceeding the maximum expansion temperature T_{Emax}. The second thermal expansion layer 22 reaches near the maximum expansion temperature T_{Emax} to increase the expansion amount, but has no further temperature increase. Specifically, the second thermal expansion layer 22 is preferably at a temperature of (T_{Emax}+5° C.) or less, more preferably at a temperature lower than T_{Emax}. Further, since the base material 1 is heated to a higher temperature immediately below the photothermal conversion member 52A than immediately below the photothermal conversion member 51A, the base material 1 is capable of plastic deformation with a lower load. Thus, even when the first thermal expansion layer 21 expands to some extent and the difference in expansion amount between the first thermal expansion layer 21 and the second thermal expansion layer 22 becomes small, the base material 1 can be bent immediately below the photothermal conversion member 52A on a par with immediately below the photothermal conversion member 51A.

As in the third embodiment, the heating rates of the photothermal conversion members 51A and 52A (the temperature increase rates of the photothermal conversion members 51A and 52A) are preferably high, and the photothermal conversion members 51A and 52A are preferably cooled at once after reaching the maximum temperatures such that the first thermal expansion layer 21 and the second thermal expansion layer 22 immediately below the photothermal conversion members 51A and 52A show the temperature gradients described above.

In the ink removal step S25, as in the first embodiment, the ink reception layer 4 is peeled off with the release layer 31 from the surface of the bent thermal expansion layer-coated resin sheet 10E, thereby to obtain the sheet formed article 13 illustrated in FIG. 17. The sheet formed article 13 is assembled and completed as illustrated in FIG. 16A, as in the third embodiment.

### Modification Example

As in the third embodiment, the photothermal conversion members 51A and 52A may remain along the ridge lines on the sheet formed article 13 depending on the application such as trial production. In this case, the thermal expansion layer-coated resin sheet 10E may not include the release layer 31. The sheet formed article 13 may be formed from only the bent base material 1 and the second thermal expansion layer 22 covering one surface of the base material 1 by peeling off the ink reception layer 4 together with the first thermal expansion layer 21 in the ink removal step S25. Alternatively, the sheet formed article 13 may be formed from only the bent base material 1 (not illustrated) by further peeling off the second thermal expansion layer 22, as with the sheet formed article 11A (see FIG. 10) according to the modification example of the first embodiment. Therefore, the thermal expansion layer-coated resin sheet 10E includes the release layer 31A, instead of the release layer 31, between the base material 1 and the first thermal expansion layer 21 and between the base material 1 and the second thermal expansion layer 22. The sheet formed article 13 can be manufactured in the same manner as the thermal expansion layer-coated resin sheet 10B (see FIG. 11) and the sheet formed article 11A in the modification example of the first embodiment.

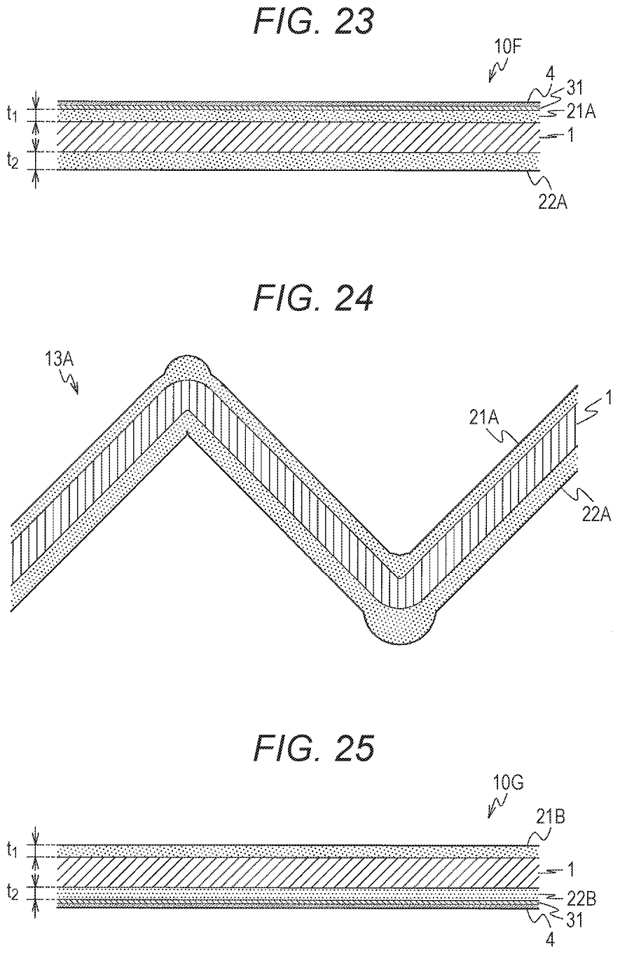

In the present embodiment, the first thermal expansion layer 21 and the second thermal expansion layer 22 are differentiated in expansion amount with different expansion coefficients. To make the base material 1 easier to bend by increasing the difference in expansion amount, as illustrated in FIG. 23, the sheet formed article 13 can be manufactured from a thermal expansion layer-coated resin sheet 10F including thermal expansion layers 21A and 22A having different initial thicknesses t₁ and t₂. Specifically, the initial thickness t₂ of the second thermal expansion layer 22A at a large distance from the printing surface (ink reception layer 4) of the thermal expansion layer-coated resin sheet 10F is thicker (t₁<t₂). Therefore, as illustrated in a cross-sectional view of FIG. 24, an obtained sheet formed article (three-dimensional object) 13A has the thermal expansion layer 22A thicker than the thermal expansion layer 21A except for the ridge lines.

The method for manufacturing the sheet formed article 13A from the thermal expansion layer-coated resin sheet 10F is the same as that of the fourth embodiment (see FIGS. 22A and 22B). That is, the thermal expansion layer-coated resin sheet 10F is folded and bent toward the second thermal expansion layer 22A immediately below the photothermal conversion member 51A due to the expansion of the first thermal expansion layer 21A. On the other hand, immediately below the photothermal conversion member 52A, the second thermal expansion layer 22A expands at a high expansion coefficient, preferably at a maximum expansion coefficient. At this time, even if the first thermal expansion layer 21A expands at an expansion coefficient similar to that of the second thermal expansion layer 22A, the expansion amount (absolute amount) of the second thermal expansion layer 22A with a larger initial thickness is larger. Thus, the thermal expansion layer-coated resin sheet 10F is folded and bent toward the first thermal expansion layer 21A. Therefore, even if the thermal expansion layers 21A and 22A have a structure (microcapsules or the like) in which the expansion coefficient does not decrease much at high temperatures exceeding the maximum expansion temperature T_{Emax}, the sheet formed article 13A with a mixture of mountain folds and valley folds by applying light to only one surface.

In the thermal expansion layer-coated resin sheet 10F, the first thermal expansion layer 21A and the second thermal expansion layer 22A need to be different only in expansion amount (absolute amount) at the same expansion rate. The first thermal expansion layer 21A and the second thermal expansion layer 22A may be adjusted such that the second thermal expansion layer 22A is larger in expansion amount than the first thermal expansion layer 21A at their respective expansion rates by not only setting the different initial thicknesses t₁ and t₂ but also changing the compound ratio of microcapsules or the like, for example.

In the method for manufacturing a sheet formed article according to the fourth embodiment, in the thermal expansion layers 21 and 22 sandwiching the base material 1 from both sides, the desired side is expanded at a relatively high expansion rate to freely produce mountain folds and valley folds using a temperature gradient caused by different distances from the photothermal conversion members 51A and 52A on surface. Alternatively, the expansion rates of the thermal expansion layers 21 and 22 can be controlled in the same manner by structuring the thermal expansion layers 21 and 22 to be different in expansion temperature range. Hereinafter, a method for manufacturing a sheet formed article according to the modification example of the fourth embodiment will be described.

In the present modification example, the sheet formed article 13 is manufactured from a thermal expansion layer-coated resin sheet 10G illustrated in FIG. 25. FIG. 25 is a cross-sectional view schematically illustrating a configuration of a thermal expansion layer-coated resin sheet which is a material of a three-dimensional object according to the modification example of the fourth embodiment of the present invention. The thermal expansion layer-coated resin sheet 10G is a flat member having a uniform thickness, and is formed by laminating a first thermal expansion layer 21B on one surface of the base material 1 and a second thermal expansion layer 22B on the other surface, and sequentially laminating a release layer 31 and an ink reception layer 4 on the second thermal expansion layer 22B. The thermal expansion layer-coated resin sheet 10G is a printed material on which photothermal conversion members 51B and 52B are to be printed in black ink on the ink reception layer 4 as with the thermal expansion layer-coated resin sheet 10E in the embodiment described above. In the present modification example, the surface of the other side on which the ink reception layer 4 is formed constitutes the printing surface.

The configurations of the base material 1, the release layer 31, and the ink reception layer 4 are as described above in relation to the first and third embodiments. The first thermal expansion layer 21B and the second thermal expansion layer 22B (hereinafter, called collectively the thermal expansion layers 21B and 22B as appropriate) have the same configuration as the thermal expansion layers 21 and 22 of the third and fourth embodiments, and have the same initial thicknesses t₁ and t₂ (t₁=t₂). However, the first thermal expansion layer 21B and the second thermal expansion layer 22B are blended so that expansion start temperatures T1_{Es} and T2_{Es} are different, and the expansion start temperature T2_{Es} of the second thermal expansion layer 22B is higher than the expansion start temperature T1_{Es} of the first thermal expansion layer 21B (T1_{Es}<T2_{Es}). A maximum expansion temperature T1_{Emax} of the first thermal expansion layer 21B is preferably lower than a maximum expansion temperature T2_{Emax} of the second thermal expansion layer 22B (T1_{Emax}<T2_{Emax}), and is further preferably lower than the expansion start temperature T2_{Es} of the second thermal expansion layer 22B (T1_{Emax}<T2_{Es}). Moreover, the thermal deformation temperature T_{D} of the thermoplastic resin constituting the base material 1 is lower than the expansion start temperature T2_{Es} of the second thermal expansion layer 22B (T_{D}<T2_{Es}). The thermal properties of the base material 1 and the thermal expansion layers 21B and 22B in the present modification example will be described below in detail in relation to the manufacturing method.

(Method for Manufacturing the Sheet Formed Article)

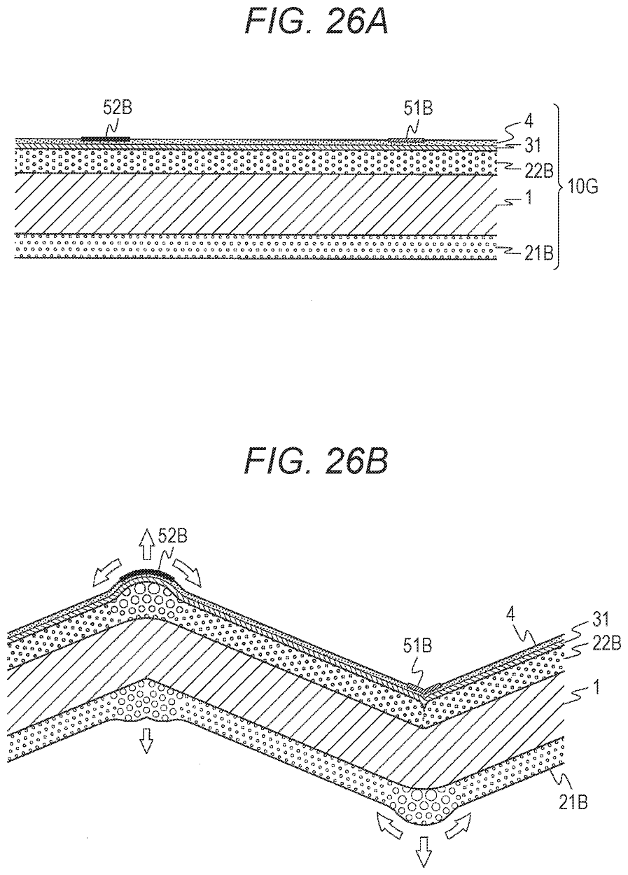

A method for manufacturing the sheet formed article according to the present modification example will be described with reference to FIGS. 26A and 26B, and FIG. 7 as appropriate. FIGS. 26A and 26B are schematic views illustrating the three-dimensional object manufacturing method according to the modification example of the fourth embodiment of the present invention. FIG. 26A is a cross-sectional view in a printing step, and FIG. 26B is a cross-sectional view in a light irradiation step. As illustrated in FIG. 7, in the method for manufacturing the sheet formed article according to the present modification example, a thermal expansion layer-coated resin sheet manufacturing step S10 of manufacturing the thermal expansion layer-coated resin sheet 10G, a printing step S21, a cutting step S23, a light irradiation step S24, and an ink removal step S25 are sequentially performed. In the thermal expansion layer-coated resin sheet manufacturing step S10, as in the embodiment described above, a thermal expansion layer formation step S11, a release layer formation step S12, and an ink reception layer formation step S13 are sequentially performed, and then a cutting step S14 is performed if necessary.

In the thermal expansion layer formation step S11, the first thermal expansion layer 21B is formed on one surface (upper side) of the base material 1, and the second thermal expansion layer 22B is formed on the other surface (lower side) with their respective thicknesses t₁ and t₂ (t₁=t₂). The formation method of the thermal expansion layers 21B and 22B is the same as the thermal expansion layer formation step S11 of the first embodiment. In the present modification example, since the first thermal expansion layer 21B and the second thermal expansion layer 22B are different in material, a slurry is prepared for each of them. Then, in the release layer formation step S12, the release layer 31 is formed on the second thermal expansion layers 22B. Then, in the ink reception layer formation step S13, the ink reception layer 4 is formed on the release layer 31. In the cutting step S14, as in the first embodiment, the base material 1 on which the thermal expansion layers 21B and 22B and others are formed is cut, thereby to obtain the thermal expansion layer-coated resin sheet 10G having a dimension corresponding to a printing machine used in the subsequent printing step S21 (see FIG. 25).

In the printing step S21, as illustrated in FIGS. 26A and 16B, the photothermal conversion members 51B and 52B (the photothermal conversion members 51 and 52 in FIG. 16B) are linearly printed in black ink on the ink reception layer 4 on the other surface of the thermal expansion layer-coated resin sheet 10G. In FIGS. 26A and 26B, the printing surface is illustrated facing upward. On the printing surface (the other surface side) of the thermal expansion layer-coated resin sheet 10G, the photothermal conversion members 51B are valley fold lines, and the photothermal conversion members 52B are mountain fold lines. Similarly to the photothermal conversion members 51A and 52A, the photothermal conversion members 51B and 52B are formed such that the photothermal conversion member 51B is lower (lighter) in black density than the photothermal conversion member 52B. As described below in detail in relation to the light irradiation step S24, the photothermal conversion member 51B generates heat to heat the base material 1 immediately below to the thermal deformation temperature T_{D} or more, and heat the first thermal expansion layer 21B lower in the expansion start temperature between the thermal expansion layers 21B and 22B to the expansion start temperature T1_{Es} or more, preferably near the maximum expansion temperature T1_{Emax} to expand the first thermal expansion layer 21B. On the other hand, the photothermal conversion member 52B generates heat to heat the second thermal expansion layer 22B immediately below to the expansion start temperature T2_{Es}, preferably near the maximum expansion temperature T2_{Emax}, heats the base material 1 to the thermal deformation temperature T_{D} or more, and further heats the first thermal expansion layer 21B to a high temperature exceeding the maximum expansion temperature T1_{Emax}. The photothermal conversion members 51B and 52B are set to their respective black densities so as to generate heat at the temperatures described above when irradiated with the same amount of light in the light irradiation step S24. Furthermore, since the first thermal expansion layer 21B expands in a region which spreads to some extent in the line width direction directly below each of the photothermal conversion members 51B and 52B, the photothermal conversion members 51B are preferably designed with a small line width within a range in which the heated area of the base material 1 is secured, similarly to the photothermal conversion members 5A in the modification example of the first embodiment. In addition, as in the first embodiment, an outline (thick line in FIG. 16B) to be a cutting line in the subsequent cutting step S23 may be printed together with the photothermal conversion members 51B and 52B.

In the cutting step S23, as in the embodiment described above, the thermal expansion layer-coated resin sheet 10G on which the photothermal conversion members 51B and 52B are formed is cut out along the outline indicated by the thick line in FIG. 16B into a developed shape of the sheet formed article 13.

In the light irradiation step S24, the cut thermal expansion layer-coated resin sheet 10G is irradiated with light by the light irradiation device 7 (7A) applied to the surface on the side (other side) on which the photothermal conversion members 51B and 52B are printed. Then, the photothermal conversion members 51B and 52B generate heat at temperatures corresponding to the respective black densities, and the heat sequentially propagates through the second thermal expansion layer 22B, the base material 1, and the first thermal expansion layer 21B. Further, immediately below the photothermal conversion member 51B, the base material 1 reaches the thermal deformation temperature T_{D} or more, and the first thermal expansion layer 21B reaches the expansion start temperature T1_{Es} or more and expands. As a result, as illustrated in FIG. 26B, the thermal expansion layer-coated resin sheet 10G is bent toward the second thermal expansion layer 22B on both sides of the line (the photothermal conversion member 51B). In addition, the second thermal expansion layer 22B nearest the photothermal conversion member 51B is at a low temperature with respect to the expansion temperature range, has a smaller expansion amount than that of the first thermal expansion layer 21B, and ideally does not reach the expansion start temperature T2_{Es} and does not expand. On the other hand, the first thermal expansion layer 21 preferably reaches around the maximum expansion temperature T1_{Emax} in order to expand more. Therefore, the photothermal conversion members 51B are designed to have a black density so as to generate heat at a temperature that is equal to or more T1_{Es} and equal to or more T_{D}, which is sufficiently lower than T2_{Emax}. The photothermal conversion members 51B are designed to have a black density so as to preferably generate heat at a temperature lower than T2_{Es}, more preferably near T1_{Emax}.

Further, immediately below the photothermal conversion member 52B, the second thermal expansion layer 22B reaches the expansion start temperature T2_{Es} or more and expands, and the base material 1 reaches the thermal deformation temperature T_{D} or more. On the other hand, the first thermal expansion layer 21B reaches a high temperature exceeding the maximum expansion temperature T_{E1max} and has a lower expansion coefficient than that of the second thermal expansion layer 22B. Therefore, as illustrated in FIG. 26B, the thermal expansion layer-coated resin sheet 10G is bent toward the first thermal expansion layer 21B on both sides of the line (the photothermal conversion member 52B). The second thermal expansion layer 22B preferably reaches around the maximum expansion temperature T2_{Emax} so as to increase the expansion amount, and the first thermal expansion layer 21B preferably reaches a temperature at which the expansion coefficient sufficiently decreases (about T1_{Es}+50 to 80° C. or more). Therefore, the photothermal conversion members 52B are designed to have a black density so as to generate heat at a temperature that is equal to or more than T2_{Es} (and equal to or more than T_{D}) and exceeds T1_{Emax}. The photothermal conversion members 52B are designed to have a black density so as to preferably generate heat at a temperature sufficiently higher than T1_{Emax}, more preferably near T2_{Emax}.

Immediately below the photothermal conversion member 52B, the base material 1 preferably reaches the thermal deformation temperature T_{D} in order to prevent plastic deformation of the base material 1 due to expansion of the first thermal expansion layer 21B, and the first thermal expansion layer 21B preferably reaches a temperature (maximum temperature) at which the expansion coefficient sufficiently decreases as in the fourth embodiment before the first thermal expansion layer 21B reaches the expansion start temperature T1_{Es} and expands to plastically deform the base material 1. Alternatively, the second thermal expansion layer 22B preferably reaches the expansion start temperature T2_{Es} and starts expansion. Therefore, the heating rate (the temperature increasing rate of the photothermal conversion members 51B and 52B) is preferably high. In the same manner as in the fourth embodiment, the base material 1 is heated to a higher temperature immediately below the photothermal conversion member 52B than immediately below the photothermal conversion member 51B, and is plastically deformable with a lower load. Further, the present modification example is effective even in a case where it is difficult to generate a sufficient temperature gradient between the thermal expansion layers 21B and 22B, such as when the base material 1 is thin.

In the ink removal step S25, as in the foregoing embodiment, the ink reception layer 4 is peeled off with the release layer 31 from the surface of the bent thermal expansion layer-coated resin sheet 10G, thereby to obtain the sheet formed article 13 illustrated in FIG. 22. The sheet formed article 13 is assembled and completed as illustrated in FIG. 16A, as in the third embodiment.

In the present modification example, as in the third and fourth embodiments, the photothermal conversion members 51B and 52B may remain along the ridge lines on the sheet formed article 13 depending on the application such as trial production. In this case, the thermal expansion layer-coated resin sheet 10G may not include the release layer 31. Further, as described in relation to the above embodiment, when the ink reception layer 4 is removed in the ink removal step S25, the ink reception layer 4 may be peeled off together with the second thermal expansion layer 22B, and further the first thermal expansion layer 21B may also be peeled off.

Also in the present modification example, as in the fourth embodiment, in order to make the base material 1 easy to bend by increasing the difference in expansion amount, the initial thicknesses t₁ and t₂ of the thermal expansion layers 21B and 22B may be made different as in the thermal expansion layer-coated resin sheet 10F (see FIG. 23). Specifically, the initial thickness t₂ of the second thermal expansion layer 22B having a higher expansion start temperature is made thicker (t₁<t₂). Even if the first thermal expansion layer 21B is structured such that the expansion coefficient is unlikely to decrease at a high temperature exceeding the maximum expansion temperature T_{E1max}, the second thermal expansion layer 22B has a larger expansion amount (absolutely amount) immediately below the photothermal conversion member 52B, and thus the thermal expansion layer-coated resin sheet 10G is folded and bent toward the first thermal expansion layer 21B. Alternatively, the first thermal expansion layer 21B and the second thermal expansion layer 22B may be adjusted at their respective maximum expansion coefficients by blending of microcapsules or the like such that the expansion amount of the second thermal expansion layer 22B becomes larger.

### Fifth Embodiment

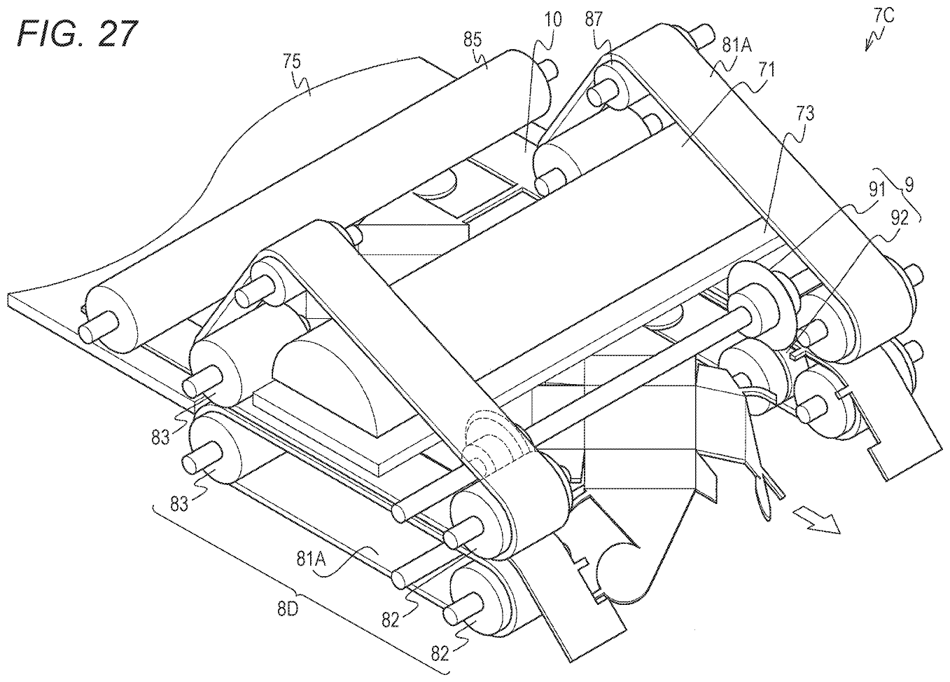

The three-dimensional object according to the present invention is manufactured by bending with light irradiation in the manufacturing process. Accordingly, when the dimension of the developed shape of the three-dimensional object before irradiation is large, a region earlier irradiated with light is bent in a state in which there remains a region yet to be irradiated with light by the light irradiation device. In this case, as described above in relation to the modification example of the first embodiment, it is possible to appropriately apply light to the three-dimensional object by conveying in a state of being held in the sheet loader. However, the conveyance may be difficult depending on the shape of the three-dimensional object. Also, the three-dimensional object is ideally in non-contact with the device when irradiated with light. Therefore, the light irradiation device is configured such that the position of the three-dimensional object is fixed in a limited manner while being in non-contact with the device in the light irradiation region. Hereinafter, a three-dimensional object manufacturing method according to a fifth embodiment of the present invention will be described with reference to FIGS. 27 and 28. FIG. 27 is an external view illustrating an outline of a light irradiation device used for manufacturing a three-dimensional object. FIG. 28 is a schematic view illustrating the three-dimensional object manufacturing method according to the fifth embodiment of the present invention, and is a plan view in a cutting step. The same elements as those in the above embodiments (see FIGS. 1 to 26) are denoted by the same reference numerals, and description thereof will be omitted.

(Light Irradiation Device)

In the present embodiment, a light irradiation device 7C illustrated in FIG. 27 is used in the light irradiation step S24. The light irradiation device 7C includes a light irradiation unit 71, a cooler 72 (not illustrated), a protection plate 73, a transport mechanism 8D, and a cutting mechanism 9. The light irradiation device 7C applies light to the upper surface of an object to be processed, like the light irradiation device 7 (see FIG. 5) used in the first, second, and fourth embodiments. The light irradiation unit 71, the cooler 72, and the protection plate 73 are structured in the same manner as those of the light irradiation device 7.

The transport mechanism 8D transports the object to be processed in one horizontal direction at a constant speed to pass the light irradiation area. The transport mechanism 8D includes total four sets of belt conveyors that are arranged on both edges to hold and transport an object to be processed of a fixed size near both ends (both edges) as seen in a transport-width direction, and are provided above and below the object to be processed such that the object to be processed is held at least in the light irradiation region. Therefore, the transport mechanism 8D includes four belts 81A, four head pulleys (drive pulleys) 82, and four tail pulleys 83, and further includes idle pulleys 87 on the upper two sets of belt conveyors and motors (not illustrated) to rotationally drive the four head pulleys 82. In addition, the transport mechanism 8D may further include a carry-in guide plate 75 and a transport roller 85 of the light irradiation device 7A behind the transport mechanism 8D.

The cutting mechanism 9 is a slitter that cuts the object to be processed continuously along the transport direction at a predetermined position inside the transport mechanism 8D as seen in the transport-width direction. The cutting mechanism 9 includes an upper blade 91 and a lower blade 92 in front of the light irradiation region near the both edges to sandwich the object to be processed from above and below. The positions of the blades 91 and 92 as seen in the transport direction are in front of the light irradiation area and behind the position where the object to be processed (the thermal expansion layer-coated resin sheet 10) starts to bend. The blades 91 and 92 are preferably adjustable in the position in the transport-width direction or in the transport direction.

According to the light irradiation device 7C, the object to be processed is stably irradiated with light in the light irradiation region without deviating from the transport path. In addition, the object to be processed is not in contact with parts of the light irradiation device 7C and others so that the heat propagation state is uniform and the expansion of the thermal expansion layer is not impeded. On the other hand, the object to be processed are cut at both edges held in the transport mechanism 8D by the cutting mechanism 9 at the time of passage through the light irradiation area, so that the bending and deformation of the object to be processed are not impeded. In addition, the light irradiation device 7C may be configured such that the light irradiation unit 71, the cooler 72, and the protection plate 73 are vertically reversed so that the lower surface of the object to be processed is irradiated with light. Alternatively, the light irradiation device 7C may include the two light irradiation units 71, the two coolers 72, and the two protection plates 73 to apply light to both sides of the object to be processed at the same time.

For light irradiation by the light irradiation device 7C, the thermal expansion layer-coated resin sheet 10 is formed such that, in the cutting step S23, a frame 10f is left at a peripheral edge and a portion of the outline is not cut but is coupled to the frame 10f by tie bars 10b as illustrated in FIG. 28. The frame 10f is a portion to be held by the transport mechanism 8D of the light irradiation device 7C. The tie bars 10b are provided to connect the thermal expansion layer-coated resin sheet 10 (before bending of the sheet formed article 11) to the frame 10f, and are cut by the cutting mechanism 9 of the light irradiation device 7C. For this purpose, the tie bars 10b are formed to be connected to both ends (both edges) of the frame 10f as seen in the transport-width direction, and extend from the outline nonparallel to the transport direction, preferably extending in the transport-width direction. The spacing (pitch) of the tie bars 10b and 10b as seen in the transport direction is formed so that, when one of the tie bars 10b is cut by the cutting mechanism 9, the following tie bar 10b passes through the light irradiation area. Furthermore, in the assembled sheet formed article 11, the tie bars 10b are preferably connected to portions not exposed to the front side.

In the light irradiation step S24, the thermal expansion layer-coated resin sheet 10 cut as described above is irradiated with light by the light irradiation device 7C, and the tie bars 10b are cut by the cutting mechanism 9 when having passed through the light irradiation region so that the thermal expansion layer-coated resin sheet 10 can start to bend along the photothermal conversion members 5. Then, after the light irradiation step S24, the remaining tie bars 10b are cut off by scissors or the like along the outline from the bent thermal expansion layer-coated resin sheet 10.

### Modification Example

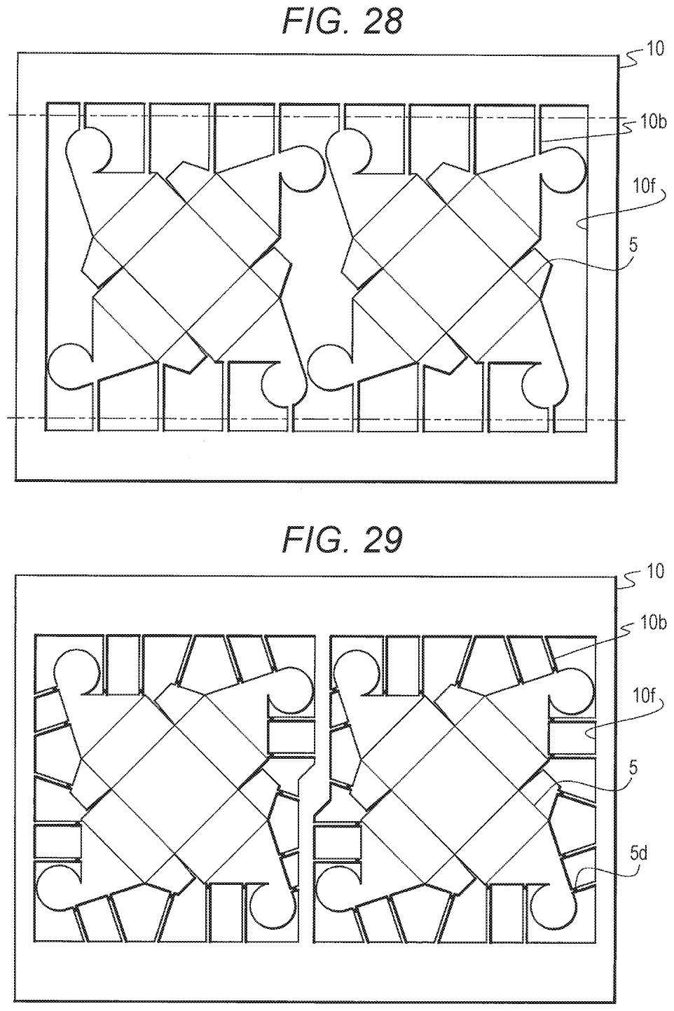

In the above embodiment, the light irradiation device includes a cutting mechanism to mechanically cut off the both edges of the object to be processed. However, the object to be processed is mainly made of a thermoplastic resin and thus the both edges of the object to be processed can be cut off without using the cutting mechanism. Hereinafter, a three-dimensional object manufacturing method according to a modification example of the fifth embodiment of the present invention will be described with reference to FIG. 29. FIG. 29 is a schematic view illustrating a three-dimensional object manufacturing method according to a modification example of the fifth embodiment of the present invention, and is a plan view in a cutting step. The same elements as those in the above embodiments (see FIGS. 1 to 27) are denoted by the same reference numerals, and description thereof will be omitted.

In the present modification example, the light irradiation device 7C (see FIG. 27) used in the above embodiment can be used, but the cutting mechanism 9 is not necessary.

As in the above embodiment, the thermal expansion layer-coated resin sheet 10 is formed such that, in the cutting step S23, a frame 10f is left at a peripheral edge and a portion of the outline is not cut but is coupled to the frame 10f by tie bars 10b as illustrated in FIG. 29. In the present modification example, the extending directions of the tie bars 10b are not particularly restricted, and the tie bars 10b may be connected to both ends of the frame 10f as seen in the transport direction. Moreover, the tie bars 10b are preferably thin as far as they can hold the coupling. Further, in the printing step S21, together with the photothermal conversion members 5, lines 5d crossing the tie bars 10b are printed in black ink. When irradiated with light by the light irradiation device 7C, the lines 5d generate heat and cut the tie bars 10b by melting the thermal expansion layer-coated resin sheet 10 (the base material 1 and the thermal expansion layer 2). Therefore, the lines 5d have a sufficiently high black density and a large line width. The positions of the lines 5d in the tie bars 10b are not particularly restricted, and may be on the outline.

In the light irradiation step S24, the thermal expansion layer-coated resin sheet 10 cut as described above is irradiated with light by the light irradiation device 7C, and the portions of the thermal expansion layer-coated resin sheet 10 having passed through the light irradiation area start to bend along the photothermal conversion members 5 and melt immediately below the lines 5d. Accordingly, the tie bars 10b are cut under the load of bending. After the light irradiation step S24, the remaining tie bars 10b are cut off by scissors or the like along the outline from the bent thermal expansion layer-coated resin sheet 10.

Each of the three-dimensional objects according to the first to fourth embodiments of the present invention has a three-dimensional shape formed by bending a flat surface, or a three-dimensional shape formed by curving a developable surface. However, since the thermoplastic resin constituting the base material is thermally deformable, a sheet formed article (not illustrated) can be manufactured with a surface similar to a three-dimensional curved surface with a skeleton of a linear area in which the photothermal conversion members are formed. The thermal expansion layer-coated resin sheet 10 is bent at each of the photothermal conversion members 5 in a narrow region between the photothermal conversion members 5 and 5 and thus is largely curved as a whole and gently curved in a wide region. Accordingly, the thermal expansion layer-coated resin sheet 10 can be changed into an arbitrary face shape by a pattern of the photothermal conversion members 5, or can be adjusted in bending angle by the black density and line width of the photothermal conversion members 5. In particular, since the base material 1 is easy to heat to the thermal deformation temperature T_{D} or more and deform immediately below and in the vicinity of the photothermal conversion members 5, forming narrowly the space between the photothermal conversion members 5 and 5 makes it possible to deform the base material 1 into smoother curved surface.

As described above, according to the present invention, it is possible to obtain a desired three-dimensional shape in which a resin sheet is bent or curved without using a mold or the like.

The present invention is not limited to the above embodiment, and can be modified without departing from the spirit of the present invention.

### Examples

Hereinafter, as examples of the present invention, samples simulating a sheet formed article according to the modification example of the first embodiment (see FIGS. 12, 13A, and 13B) were prototyped under different conditions, and were checked for their advantageous effects. In each of the examples, a thermal expansion layer-coated resin sheet (thermal expansion layer/base material/ink reception layer) was produced with the ink reception layer provided only on the base material. As a base material, a non-crystalline polyethylene terephthalate (A-PET, thermal deformation temperature 70 to 80° C.) film of 180 μm thickness was used. An ink reception layer was formed on one surface (back surface) of the base material, and an ethylene-vinyl acetate copolymer (EVA) resin containing microcapsules was applied to the other surface (front surface) to form a thermal expansion layer having a thickness of 60 to 80 μm, thereby producing a thermal expansion layer-coated resin sheet having a total thickness of 250 μm. The microcapsules of the thermal expansion layer were Matsumoto Microsphere (registered trademark) F-36 LV manufactured by Matsumoto Yushi-Seiyaku Co., Ltd., which had an average particle diameter of 13 to 19 μm, a foaming start temperature of 75 to 85° C., and a maximum expansion temperature of 110 to 120° C. In addition, in some of the thermal expansion layer-coated resin sheets (see Table 2), an EVOH resin film (EVAL manufactured by Kuraray Co., Ltd.) was attached to the surface of the base material as a release layer (see FIG. 11), and a thermal expansion layer was formed on the release layer with a total thickness of 272 μm (thermal expansion layer/release layer/base material/ink reception layer).

Straight lines with the black density and the line width illustrated in Table 1 and Table 2 were printed using an ink jet printer in black ink (photothermal conversion members) on the back surface (ink reception layer) of the produced thermal expansion layer-coated resin sheet, and then the thermal expansion layer-coated resin sheet was cut into a rectangle of 15 mm×30 mm. In each of the cut thermal expansion layer-coated resin sheets, the printed straight line is oriented in the short-side direction at a position of 10 mm from one end as seen in the longitudinal direction. The thermal expansion layer-coated resin sheet was placed with the back surface (printing surface) oriented upward, and while about ⅔ of the thermal expansion layer-coated resin sheet on the one end side as seen in the longitudinal direction was protruded, the remaining portion (about ⅓ as seen in the longitudinal direction) was stuck to an upper surface of a square block with a double-sided tape. Then, the thermal expansion layer-coated resin sheet was fixed from above by a cellophane tape. The fixed thermal expansion layer-coated resin sheet was held horizontally including the portion protruding from the square block, and the lower surface (thermal expansion layer) of the protruding portion was made noncontact. Finally, the thermal expansion layer-coated resin sheet was irradiated with light by a near-infrared heater from above 20 mm. At this time, the near-infrared heater was horizontally moved at the movement speeds illustrated in Table 1 and Table 2 so as to cross the printed straight line from the side of the thermal expansion layer-coated resin sheet fixed to the square block (in the longitudinal direction of the thermal expansion layer-coated resin sheet). The movement speeds of 650, 700 and 750 pps (pulses/second) correspond to linear speeds of 27.1, 29.2 and 31.2 mm/s, respectively. The near-infrared heater used a 1000 W straight-tube type halogen lamp as a light source, and was a parabola (diffusion) type equipped with a reflector of about 45 mm in width, and was attached to a linear-motion mechanism so as to be movable in the width direction. Tables 1 and 2 show the visually measured bending angles of the thermal expansion layer-coated resin sheets (samples) irradiated with light.

TABLE 1

| Black ink | | Angle of bend (deg.) | | |
|---|---|---|---|---|
| Black density | Line width | Halogen lamp moving speed (pps) | | |
| (%) | (mm) | 750 | 700 | 650 |
| 20 | 1.8 | 0 | 0 | 0 |
| 30 | 1.8 | 0 | 0 | 5 |
| 40 | 1.8 | 0 | 20 | 70 |
| 50 | 1.8 | 50 | 50 | 120 |
| 60 | 1.8 | 90 | 110 | 150 |
| 70 | 1.8 | 110 | 130 | 170 |
| 80 | 1.8 | 140 | 150 | 180 |
| 90 | 1.8 | 150 | 160 | 180 |
| 100 | 1.8 | 140 | 180 | 180 |

TABLE 2

| Black ink | | Angle of bend (deg.) | | |
|---|---|---|---|---|
| Black density | Line width | Halogen lamp moving speed (pps) | | |
| (%) | (mm) | 750 | 700 | 700* |
| 100 | 0.2 | 0 | 0 | 0 |
| 100 | 0.4 | 0 | 15 | 0 |
| 100 | 0.6 | 20 | 50 | 0 |
| 100 | 0.8 | 45 | 65 | 10 |
| 100 | 1.0 | 70 | 95 | 40 |
| 100 | 1.2 | 90 | 120 | 60 |
| 100 | 1.4 | 110 | 135 | 70 |
| 100 | 1.6 | 130 | 165 | 90 |
| 100 | 1.8 | 150 | 180 | 110 |
| 100 | 2.0 | 160 | 180 | 140 |
| 100 | 2.5 | 180 | 180 | 180 |

*Sheet with release layer

When irradiated with light, each of the thermal expansion layer-coated resin sheets was bent with the printed straight lines as concave ridges and the downward surface (thermal expansion layer) oriented outward, and was deformed such that one longitudinal end not fixed to the square block stood up. As illustrated in Tables 1 and 2, the higher the linear black density and the longer the line width, the larger the bending angle became, 180° at maximum, that is, the thermal expansion layer-coated resin sheet was completely folded. However, in samples printed in a light straight line with black density below a certain level or a thin straight line with a maximum black density (100%) and a line width smaller than a specific value or lower, each of the thermal expansion layer-coated resin sheets had the bending angle of 0°, that is, did not bend and remained flat. In addition, in samples at slow movement speeds of the halogen lamp, that is, samples with long light irradiation times, each of the thermal expansion layer-coated resin sheets had a large bending angle and was bent even along a light straight line or a thin straight line. In addition, the thermal expansion layer-coated resin sheets provided with the release layer had smaller bending angles than those without the release layer.

As described above, when the black density and the line width of the photothermal conversion member are set to specific values or more, the thermal expansion layer is heated to a temperature higher than the expansion start temperature and expands in the area where the photothermal conversion members are printed. As a result, the thermal expansion layer-coated resin sheet can be bent. Furthermore, by printing with a high black density and a large line width, the thermal expansion layer expands greatly, and the base material is heated and softened, and as a result, the bending angle can be increased. In addition, when the light irradiation time is made longer, the temperatures of the photothermal conversion member and the thermal expansion layer increase. Thus, even when the photothermal conversion member is low in black density or small in line width, the thermal expansion layer can be expanded and the thermal expansion layer-coated resin sheet can be bent, thereby further increasing the bending angle. In addition, the thermal expansion layer-coated resin sheet is more difficult to bend as the thickness of the base material or the total thickness including the thickness of the release layer is larger. Therefore, the black density and the line width, and the light irradiation time are preferably set according to the thickness and the required bending angle of the base material. In particular, as in the present example, the thermal expansion layer and the thermal expansion layer-coated resin sheet with the surface opposite to the thermal expansion layer as the printing surface are separated by the base material or the like. Accordingly, it is considered that, as the base material or the like is thicker, it takes more time that heat propagates from the photothermal conversion member to the thermal expansion layer, and the thermal expansion layer-coated resin sheet is unlikely to be bent when the light irradiation time is short.

What is claimed is:

1. A three-dimensional object formed by bending and deforming a sheet-like base material made of a thermoplastic resin at a ridge line, wherein
a surface of the base material bent and oriented outward at least at the ridge line is covered with a thermal expansion layer that expands when heated to a thermal deformation temperature of the thermoplastic resin or a higher temperature, and
the thermal expansion layer is expanded at the ridge line.

2. The three-dimensional object according to claim 1, wherein
the thermal expansion layer covers both surfaces of the base material, and
the thermal expansion layer on the bent outer side of the base material has a larger expansion amount than the thermal expansion layer on the inner side at the ridge line.

3. The three-dimensional object according to claim 2, wherein the thermal expansion layer is thicker on one surface of the base material than on another surface of the base material except for the ridge line.

4. The three-dimensional object according to claim 1, wherein a photothermal conversion component is attached to at least one surface at the ridge line to convert absorbed light into heat and emit the heat.

5. The three-dimensional object according to claim 1, wherein
the base material transmits light, and
a photothermal conversion component is attached at the ridge line to a surface between the thermal expansion layer and the base material to convert absorbed light into heat and emit the heat.

6. The three-dimensional object according to claim 4, wherein an ink reception layer is formed on the surface to which the photothermal conversion component is attached.

7. The three-dimensional object according to claim 1, wherein the base material bends more greatly as the ridge line is thicker.

8. A three-dimensional object manufacturing method comprising:
a thermal expansion layer formation step of forming a thermal expansion layer to expand when heated to a predetermined temperature range on a sheet-like base material made of a thermoplastic resin of which a thermal deformation temperature is equal to or lower than the predetermined temperature range;
a printing step of drawing a line on at least one surface of a thermal expansion sheet on which the thermal expansion layer is formed in the thermal expansion layer formation step by a printing material that contains a photothermal conversion component to convert absorbed light into heat and emit the heat; and
a light irradiation step of irradiating the surface on which the line is drawn with light to be converted into heat by the photothermal conversion component, wherein
in the light irradiation step, the thermal expansion layer immediately below the line is expanded and the base material is bent at the line such that the expanded thermal expansion layer is oriented outward.

9. The three-dimensional object manufacturing method according to claim 8, wherein
in the thermal expansion layer formation step, the thermal expansion layer is formed on both surfaces of the base material, and
in the light irradiation step, the thermal expansion layers on the both surfaces immediately below the line are expanded so that expansion amounts are different from each other, and the thermal expansion layer having the larger expansion amount is bent outward at the line.

10. The three-dimensional object manufacturing method according to claim 9, wherein, in the thermal expansion layer formation step, the thermal expansion layer is formed to be thicker on one surface of the base material than on another surface.

11. The three-dimensional object manufacturing method according to claim 8, wherein
before the thermal expansion layer formation step, a release layer formation step of forming a release layer between the base material and the thermal expansion layer is performed, and
after the light irradiation step, a thermal expansion layer removal step of peeling and removing the thermal expansion layer from the base material with the release layer is performed.

12. The three-dimensional object manufacturing method according to claim 8, wherein the base material is bent more greatly as the line is thicker.

13. A three-dimensional object manufacturing method comprising:
a printing step of drawing a line by a printing material that contains a photothermal conversion component to convert absorbed light into heat and emit the heat;
a thermal expansion layer formation step of forming a thermal expansion layer to expand when heated to a predetermined temperature range on one surface of a sheet-like base material that is made of a thermoplastic resin of which a thermal deformation temperature is equal to or lower than the predetermined temperature range and transmits the light; and
a light irradiation step of irradiating the base material with light to be converted into heat by the photothermal conversion component, wherein
in the printing step, the line is drawn on the one surface of the base material or the base material side of the thermal expansion layer, and
in the light irradiation step, the thermal expansion layer immediately below the line is expanded and the base material is bent at the line such that the one surface is oriented outward.

14. The three-dimensional object manufacturing method according to claim 13, wherein
before the printing step, an ink reception layer formation step of forming a reception layer of the printing material is performed, and
in the printing step, the line is drawn on a surface of the reception layer.

15. The three-dimensional object manufacturing method according to claim 14, wherein
before the ink reception layer formation step, a release layer formation step of forming a release layer is performed,
in the ink reception layer formation step, the reception layer is formed on the release layer, and
after the light irradiation step, an ink removal step of peeling and removing the reception layer with the release layer is performed.

16. The three-dimensional object manufacturing method according to claim 14, wherein
before the thermal expansion layer formation step, a release layer formation step of forming a release layer between the base material and the thermal expansion layer is performed, and
after the light irradiation step, a thermal expansion layer removal step of peeling and removing the thermal expansion layer from the base material with the release layer is performed.

17. The three-dimensional object manufacturing method according to claim 16, wherein, before the light irradiation step, a cutting step of cutting the base material and processing into a desired plan-view shape is performed.

18. The three-dimensional object manufacturing method according to claim 17, wherein
in the cutting step, the base material is cut with left a portion of the outline of the plan-view shape, such that the base material has one or more coupling portions that couple from the portion of the outline to a peripheral edge before the cutting step, and
after or simultaneously with the light irradiation step, the coupling portion of the base material is cut along the outline.

19. The three-dimensional object manufacturing method according to claim 18, wherein
in the printing step, a line passing across the coupling portion is further drawn by the printing material, and
in the light irradiation step, the coupling portion of the base material is melted and cut at the line passing across the coupling portion.

20. The three-dimensional object manufacturing method according to claim 13, wherein the base material is bent more greatly as the line is thicker.
